(19) United States
(12) Patent Application Publication
(10) Pub. No.: US 2026/0012746 A1
(43) Pub. Date: Jan. 8, 2026

(54) FILTER GENERATION DEVICE, FILTER GENERATION METHOD, AND OUT-OF-HEAD LOCALIZATION DEVICE

(71) Applicant: JVCKENWOOD Corporation, Yokohama-shi (JP)

(72) Inventors: Hisako MURATA, Yokohama-shi (JP); Kazuki KANAE, Yokohama-shi (JP)

(21) Appl. No.: 19/257,136

(22) Filed: Jul. 1, 2025

Related U.S. Application Data
(63) Continuation of application No. PCT/JP2023/046958, filed on Dec. 27, 2023.

(30) Foreign Application Priority Data
Jan. 6, 2023 (JP) 2023-001006
Jan. 6, 2023 (JP) 2023-001007
Jan. 6, 2023 (JP) 2023-001008

(51) Int. Cl. H04S 7/00

(52) U.S. Cl. CPC H04S 7/307; H04S 7/302; H04S 2400/11; H04S 2420/01

(57) ABSTRACT

A filter generation device according to this embodiment includes: a transfer characteristic acquisition unit configured to acquire spatial acoustic transfer characteristics from a sound source to an ear of a person being measured; a positional information acquisition unit configured to acquire positional information of the sound source in a vertical direction; a correction unit configured to correct spatial acoustic transfer characteristics based on the positional information; and a filter generation unit configured to generate a correction filter based on the corrected spatial acoustic transfer characteristics.

### CROSS REFERENCE TO RELATED APPLICATION

This application is based upon and claims the benefit of priority from Japanese patent application No. 2023-001006, filed on January 6, 2023, Japanese Patent Application No. 2023-001007, filed on January 6, 2023, and Japanese Patent Application No. 2023-001008, filed on January 6, 2023, the disclosure of which is incorporated herein in its entirety by reference.

### BACKGROUND

The present disclosure relates to a filter generation device, a filter generation method, and an out-of-head localization device. Sound localization techniques include an out-of-head localization technique, which localizes sound images outside the head of a listener by using headphones. The out-of-head localization technique localizes sound images outside the head by canceling characteristics from the headphones to the ears and giving four characteristics from stereo speakers to the ears.

In out-of-head localization reproduction, measurement signals (impulse sounds etc.) that are output from 2-channel (which is referred to hereinafter as "ch") speakers are recorded by microphones placed on the listener (user)'s ears. Then, a processor generates a filter based on a sound pickup signal obtained by impulse response. Accordingly, a filter in accordance with spatial acoustic transfer characteristics from the speakers to the ear canal where the microphones are placed is generated. The generated filter is convolved to 2-ch audio signals, thereby implementing out-of-head localization reproduction.

Further, in order to generate a filter for canceling out characteristics from headphones to ears, characteristics from the headphones to a part near the ear or to an eardrum (ear canal transfer function ECTF; also referred to as ear canal transfer characteristics) are measured by microphones worn on listener's ears.

Patent Literature 1 discloses a signal processing apparatus that generates a head-related transfer function in accordance with a direction and a size of a virtual sound source. This signal processing apparatus specifies a range of an elevation angle corresponding to the virtual sound source and acquires a head-related transfer function that corresponds to this range. Then notches of a frequency spectrum of the head-related transfer function indicated by the acquired information are changed.

[Patent Literature 1] Japanese Unexamined Patent Application Publication No. 2020-88632

### SUMMARY

When the direction of the sound source is changed, spatial acoustic transfer characteristics from the sound source to the ears are changed. Therefore, if the direction of the virtual sound source is changed, it is desired to correct data obtained by measurement more appropriately. According to the method disclosed in Patent Literature 1, a notch width is adjusted, whereby it is possible that characteristics may change greatly. Therefore, it is possible that an appropriate localization effect cannot be obtained.

The present disclosure has been made in view of the aforementioned circumstances and an object of the present disclosure is to provide a filter generation device, a filter generation method, and an out-of-head localization device capable of using an appropriate filter even when a position of a sound source is changed.

A filter generation device according to this embodiment includes: a transfer characteristic acquisition unit configured to acquire spatial acoustic transfer characteristics from a sound source to an ear of a person being measured; a positional information acquisition unit configured to acquire positional information of the sound source in a vertical direction; a specifying unit configured to specify notches of frequency characteristics of the spatial acoustic transfer characteristics; a correction unit configured to correct, based on the positional information, a frequency and a level of a second notch, which is on the second of the frequency characteristics from a low-frequency side; and a filter generation unit configured to generate a correction filter based on the corrected spatial acoustic transfer characteristics.

A filter generation method according to this embodiment includes: a step of acquiring spatial acoustic transfer characteristics from a sound source to an ear of a person being measured; a step of acquiring positional information of the sound source in a vertical direction; a step of specifying a notch of frequency characteristics of the spatial acoustic transfer characteristics; a step of correcting, based on the positional information, a frequency and a level of a second notch, which is on the second of the frequency characteristics from a low-frequency side; and a step of generating a correction filter based on the corrected spatial acoustic transfer characteristics.

A filter generation device according to this embodiment includes: a transfer characteristic acquisition unit configured to acquire spatial acoustic transfer characteristics from a sound source to an ear of a person being measured; a positional information acquisition unit configured to acquire positional information of the sound source in a vertical direction; a specifying unit configured to specify a peak or a notch of frequency characteristics of the spatial acoustic transfer characteristics; a setting unit configured to set a shift region including the peak or the notch of the frequency characteristics; a correction unit configured to correct the spatial acoustic transfer characteristics by shifting data in the shift region in accordance with the positional information while maintaining a shape of the peak or the notch in the shift region; and a filter generation unit configured to generate a correction filter based on the corrected spatial acoustic transfer characteristics.

A filter generation method according to this embodiment includes: a step of acquiring spatial acoustic transfer characteristics from a sound source to an ear of a person being measured; a step of acquiring positional information of the sound source in a vertical direction; a step of specifying a peak or a notch of frequency characteristics of the spatial acoustic transfer characteristics; a step of setting a shift region including the peak or the notch of the frequency characteristics; a step of correcting the spatial acoustic transfer characteristics by shifting data in the shift region in accordance with the positional information while maintaining a shape of the peak or the notch in the shift region; and a step of generating a correction filter based on the corrected spatial acoustic transfer characteristics.

A filter generation device according to this embodiment includes: a preset data storage unit configured to store preset data in accordance with spatial acoustic transfer characteristics from a sound source to an ear of a person being measured, the preset data storage unit storing preset data in accordance with the spatial acoustic transfer characteristics obtained by measurement on a plurality of persons being measured; a transfer characteristic extraction unit configured to extract spatial acoustic transfer characteristics from the preset data storage unit; a correction data storage unit configured to store correction data for correcting the spatial acoustic transfer characteristics in accordance with the position of the sound source in a vertical direction, the correction data storage unit storing, for each of the persons being measured, correction data obtained from frequency characteristics of spatial acoustic transfer characteristics measured by changing the position of the sound source in the vertical direction relative to the person being measured; an acquisition unit configured to acquire positional information of the sound source in the vertical direction; a correction unit configured to correct the spatial acoustic transfer characteristics by using the correction data, the correction unit correcting a peak and a notch of the frequency characteristics of the spatial acoustic transfer characteristics in accordance with the positional information; and a filter generation unit configured to generate a correction filter based on the corrected spatial acoustic transfer characteristics.

A filter generation method according to this embodiment is a filter generation method in a system including: a preset data storage unit configured to store preset data regarding spatial acoustic transfer characteristics from a sound source to an ear of a person being measured, the preset data storage unit storing preset data obtained by measurement on a plurality of persons being measured; and a correction data storage unit configured to store correction data for correcting spatial acoustic transfer characteristics according to a position of the sound source in a vertical direction, the correction data storage unit storing, for each of the persons being measured, correction data obtained from frequency characteristics of spatial acoustic transfer characteristics measured by changing the position of the sound source in the vertical direction relative to the person being measured, the filter generation method including: a step of extracting spatial acoustic transfer characteristics based on selected data selected from the preset data storage unit; a step of acquiring positional information in the vertical direction of the sound source that the person being measured listens to; a step of correcting the spatial acoustic transfer characteristics using the correction data, the step including correcting a peak and a notch of the frequency characteristics of the spatial acoustic transfer characteristics in accordance with the positional information; and a step of generating a correction filter based on the corrected spatial acoustic transfer characteristics.

According to the present disclosure, it is possible to provide a filter generation device, a filter generation method, and an out-of-head localization device capable of appropriately determining a filter.

### BRIEF DESCRIPTION OF THE DRAWINGS

FIG. 1 is a block diagram showing an out-of-head localization device according to this embodiment;

FIG. 2 is a diagram showing a configuration of a measurement device that measures spatial acoustic transfer characteristics;

FIG. 3 is a block diagram showing a configuration of the out-of-head localization device that uses corrected spatial acoustic transfer characteristics;

FIG. 4 is a block diagram showing a configuration of the out-of-head localization device that uses corrected spatial acoustic transfer characteristics;

FIG. 5 is a diagram showing a GUI for adjusting a position of a virtual sound source;

FIG. 6 is a graph showing frequency-amplitude characteristics in a case where a sound source is raised from a reference position;

FIG. 7 is a graph showing frequency-amplitude characteristics in the case where the sound source is raised from the reference position;

FIG. 8 is a graph showing frequency-amplitude characteristics in the case where the sound source is raised from the reference position;

FIG. 9 is a graph showing frequency-amplitude characteristics in the case where the sound source is raised from the reference position;

FIG. 10 is a graph showing frequency-amplitude characteristics in a case where the sound source is lowered from the reference position;

FIG. 11 is a graph showing frequency-amplitude characteristics in the case where the sound source is lowered from the reference position;

FIG. 12 is a graph showing frequency-amplitude characteristics in the case where the sound source is lowered from the reference position;

FIG. 13 is a graph showing frequency-amplitude characteristics in the case where the sound source is lowered from the reference position;

FIG. 14 is a diagram showing a peak notch table showing frequencies of peaks and notches obtained at one sound source position;

FIG. 15 is a graph showing a change in an amplitude level for each peak and each notch in a case where the position of the sound source is changed;

FIG. 16 is a graph showing a change in the frequency for each peak and each notch in the case where the position of the sound source is changed;

FIG. 17 is a diagram for describing processing for shifting a notch N2;

FIG. 18 is a diagram for interpolating data around the notch N2;

FIG. 19 is a diagram for describing processing for shifting a notch in a correction unit;

FIG. 20 is a flowchart showing a method for generating a filter in the out-of-head localization device;

FIG. 21 is a flowchart showing processing for correcting a notch N1; and

FIG. 22 is a flowchart showing processing for correcting the notch N2.

### DETAILED DESCRIPTION

The overview of sound localization processing according to this embodiment is described hereinafter. Out-of-head localization processing according to this embodiment performs out-of-head localization processing by using spatial acoustic transfer characteristics and ear canal transfer characteristics. The spatial acoustic transfer characteristics are transfer characteristics from a sound source such as a speaker to the ear canal. The ear canal transfer characteristics are transfer characteristics from a speaker unit of headphones or earphones to the eardrum. In this embodiment, the spatial acoustic transfer characteristics are measured with no headphones or no earphones worn, the ear canal transfer characteristics are measured with headphones or earphones worn, and out-of-head localization processing is implemented with these measurement data. One of the features of this embodiment is a microphone system for measuring spatial acoustic transfer characteristics or ear canal transfer characteristics.

The out-of-head localization processing according to this embodiment is executed on a user terminal such as a personal computer, a smart phone, or a tablet PC. The user terminal is an information processing device including processing means such as a processor, storage means such as a memory or a hard disk, display means such as a liquid crystal monitor, and input means such as a touch panel, a button, a keyboard and a mouse. The user terminal may have a communication function for transmitting and receiving data. Further, the user terminal is connected to output means (an output unit) with headphones or earphones. The connection between the user terminal and the output means may be a wired connection or a wireless connection.

### (Out-of-head localization device)

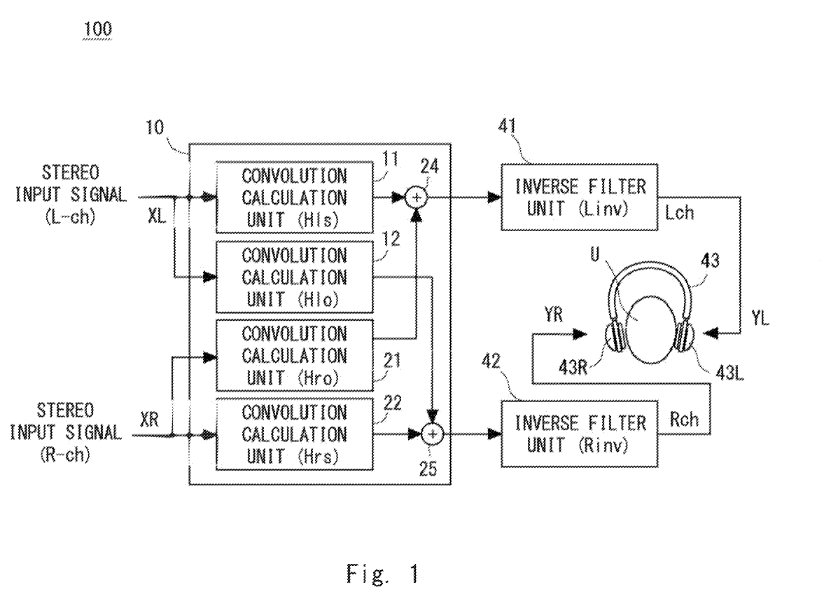

FIG. 1 shows a block diagram of an out-of-head localization device 100, which is an example of a sound field reproducing device according to this embodiment. The out-of-head localization device 100 reproduces a sound field for a user U who wears headphones 43. Thus, the out-of-head localization device 100 performs sound localization processing for L-ch and R-ch stereo input signals XL and XR. The L-ch and R-ch stereo input signals XL and XR are analog audio reproduced signals that are output from a CD (Compact Disc) player or the like or digital audio data such as mp3 (MPEG Audio Layer-3). Note that the audio reproduced signals or digital audio data are collectively referred to as a reproduced signal. In other words, the L-ch and R-ch stereo input signals XL and XR are reproduced signals.

In this embodiment, the out-of-head localization device 100 performs arithmetic processing for appropriately generating filters. An arithmetic processing unit of the out-of-head localization device 100 is a personal computer (PC), a tablet terminal, a smart phone, or the like, and includes a memory and a processor. The memory stores processing programs, various parameters, measurement data, and the like. The processor executes a processing program stored in the memory. The processor executes the processing program and thereby each process is executed. The processor may be, for example, a CPU (Central Processing Unit), an FPGA (Field-Programmable Gate Array), a DSP (Digital Signal Processor), an ASIC (Application Specific Integrated Circuit), a GPU (Graphics Processing Unit), or the like.

Note that the out-of-head localization device 100 is not limited to a physically single device, and a part of processing may be performed in a different device. For example, a part of processing may be performed by a smart phone or the like, and the remaining processing may be performed by a DSP (Digital Signal Processor) built in the headphones 43.

The out-of-head localization device 100 includes an out-of-head localization unit 10, an inverse filter unit 41 for storing an inverse filter Linv, an inverse filter unit 42 for storing an inverse filter Rinv, and headphones 43. The out-of-head localization unit 10, the inverse filter unit 41, and the inverse filter unit 42 can be specifically implemented by a processor or the like. The out-of-head localization unit 10 includes convolution calculation units 11 to 12 and 21 to 22 for storing the spatial acoustic transfer characteristics Hls, Hlo, Hro, and Hrs, and adders 24, 25. The convolution calculation units 11 to 12 and 21 to 22 perform convolution processing using the spatial acoustic transfer characteristics. The stereo input signals XL and XR from a CD player or the like are input to the out-of-head localization unit 10. The spatial acoustic transfer characteristics are set to the out-of-head localization unit 10. The out-of-head localization unit 10 convolves a filter of the spatial acoustic transfer characteristics (which is hereinafter referred to also as a spatial acoustic filter) into each of the stereo input signals XL and XR. The spatial acoustic transfer characteristics may be a head-related transfer function HRTF measured in the head or auricle of a person being measured, or may be the head-related transfer function of a dummy head or a third person.

The spatial acoustic transfer function is a set of four spatial acoustic transfer characteristics Hls, Hlo, Hro and Hrs. Data used for convolution in the convolution calculation units 11 to 12 and 21 to 22 is a spatial acoustic filter. The spatial acoustic filter is generated by cutting out the spatial acoustic transfer characteristics Hls, Hlo, Hro and Hrs with a predetermined filter length.

Each of the spatial acoustic transfer characteristics Hls, Hlo, Hro and Hrs is acquired in advance by impulse response measurement or the like. For example, the user U wears respective microphones on the left and right ears. Left and right speakers placed in front of the user U output impulse sounds for performing impulse response measurements. Then, the measurement signals such as the impulse sounds output from the speakers are picked up by the microphones. The spatial acoustic transfer characteristics Hls, Hlo, Hro and Hrs are acquired based on sound pickup signals in the microphones. The spatial acoustic transfer characteristics Hls between the left speaker and the left microphone, the spatial acoustic transfer characteristics Hlo between the left speaker and the right microphone, the spatial acoustic transfer characteristics Hro between the right speaker and the left microphone, and the spatial acoustic transfer characteristics Hrs between the right speaker and the right microphone are measured.

The convolution calculation unit 11 convolves the spatial acoustic filter in accordance with the spatial acoustic transfer characteristics Hls to the L-ch stereo input signal XL. The convolution calculation unit 11 outputs convolution calculation data to the adder 24. The convolution calculation unit 21 convolves the spatial acoustic filter in accordance with the spatial acoustic transfer characteristics Hro to the R-ch stereo input signal XR. The convolution calculation unit 21 outputs convolution calculation data to the adder 24. The adder 24 adds the two pieces of convolution calculation data and outputs the resultant data to the inverse filter unit 41.

The convolution calculation unit 12 convolves the spatial acoustic filter in accordance with the spatial acoustic transfer characteristics Hlo to the L-ch stereo input signal XL. The convolution calculation unit 12 outputs the convolution calculation data to the adder 25. The convolution calculation unit 22 convolves the spatial acoustic filter in accordance with the spatial acoustic transfer characteristics Hrs to the R-ch stereo input signal XR. The convolution calculation unit 22 outputs convolution calculation data to the adder 25. The adder 25 adds the two pieces of convolution calculation data and outputs the resultant data to the inverse filter unit 42.

Inverse filters Linv and Rinv that cancel headphone characteristics (characteristics between the reproduction unit of the headphones and the microphone) are set in the inverse filter units 41 and 42. Then, the inverse filters Linv and Rinv are convolved into the reproduced signals (convolution calculation signals) on which the processing in the out-of-head localization unit 10 has been performed. The inverse filter unit 41 convolves the inverse filter Linv of the L-ch headphone characteristics into the L-ch signal from the adder 24. Likewise, the inverse filter unit 42 convolves the inverse filter Rinv of the R-ch headphone characteristics into the R-ch signal from the adder 25. The inverse filters Linv and Rinv cancel out the characteristics from the headphone unit to the microphone when the headphones 43 are worn. The microphone may be placed at any position between the entrance of the ear canal and the eardrum.

The inverse filter unit 41 outputs the processed L-ch signal YL to the left unit 43L of the headphones 43. The inverse filter unit 42 outputs the processed R-ch signal YR to the right unit 43R of the headphones 43. The user U wears the headphones 43. The headphones 43 output the L-ch signal YL and the R-ch signal YR (hereinafter, the L-ch signal YL and the R-ch signal YR are collectively referred to as a stereo signal) toward the user U. This can reproduce sound images localized outside the head of the user U.

As described above, the out-of-head localization device 100 performs out-of-head localization processing using the spatial acoustic filters in accordance with the spatial acoustic transfer characteristics Hls, Hlo, Hro, and Hrs, and the inverse filters Linv and Rinv of the headphone characteristics. In the following description, the spatial acoustic filters in accordance with the spatial acoustic transfer characteristics Hls, Hlo, Hro, and Hrs, and the inverse filters Linv and Rinv of the headphone characteristics are collectively referred to as an out-of-head localization processing filter. In the case of 2ch stereo reproduced signals, the out-of- head localization filter is composed of four spatial acoustic filters and two inverse filters. The out-of-head localization device 100 then carries out convolution calculation processing on the stereo reproduced signals by using the out-of-head localization filter composed of totally six filters and thereby performs out-of-head localization processing. The out-of-head localization filter is preferably based on the measurement of the individual user U. For example, the out-of-head localization filter is set based on sound pickup signals picked up by the microphones worn on the ears of the user U.

As described above, the spatial acoustic filters and the inverse filters Linv and Rinv for headphone characteristics are filters for audio signals. These filters are convolved into the reproduced signals (stereo input signals XL and XR), whereby the out-of-head localization device 100 executes the out-of-head localization processing. In this embodiment, processing for generating the spatial acoustic filter is one of technical features. Specifically, in the processing for generating the spatial acoustic filter, level range compression is performed on frequency characteristics.

### (Measurement Device of Spatial Acoustic Transfer Characteristics)

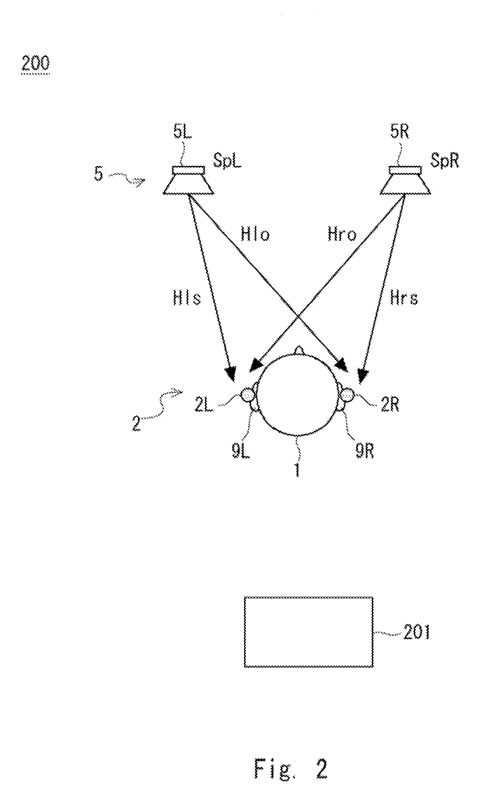

With reference to FIG. 2, a measurement device 200 for measuring the spatial acoustic transfer characteristics Hls, Hlo, Hro and Hrs is described hereinafter. FIG. 2 is a view schematically showing a measurement configuration for carrying out measurement on a person 1 being measured. In this example, the person 1 being measured is different from the user U shown in FIG. 1.

As shown in FIG. 2, the measurement device 200 includes a stereo speaker 5 and a microphone unit 2. The stereo speaker 5 is placed in a measurement environment. The measurement environment may be the user U's room at home, a dealer or showroom of an audio system or the like. The measurement environment is preferably a listening room where speakers and acoustics are in good condition.

In this embodiment, a measurement processor 201 of the measurement device 200 performs processing for appropriately generating the spatial acoustic filter. The measurement processor 201 includes a music player such as a CD player, for example. The measurement processor 201 may be a personal computer (PC), a tablet terminal, a smartphone or the like. Further, the measurement processor 201 may be a server device.

The stereo speaker 5 includes a left speaker 5L and a right speaker 5R. For example, the left speaker 5L and the right speaker 5R are placed in front of the person 1 being measured. The left speaker 5L and the right speaker 5R output impulse sounds for impulse response measurement and the like. Although the number of speakers, which serve as sound sources, is 2 (stereo speakers) in this embodiment, the number of sound sources to be used for measurement is not limited to 2, and it may be any number equal to or larger than 1. Therefore, this embodiment is applicable also to 1ch mono or 5.1ch, 7.1ch etc. multichannel environment.

The microphone unit 2 is stereo microphones including a left microphone 2L and a right microphone 2R. The left microphone 2L is placed on a left ear 9L of the person 1 being measured, and the right microphone 2R is placed on a right ear 9R of the person 1 being measured. To be specific, the microphones 2L and 2R are preferably placed at a position between the entrance of the ear canal and the eardrum of the left ear 9L and the right ear 9R, respectively. The microphones 2L and 2R pick up measurement signals output from the stereo speaker 5 and acquire sound pickup signals. The microphones 2L and 2R output the sound pickup signals to the measurement processor 201. The person 1 being measured may be a person or a dummy head. In other words, in this embodiment, the person 1 being measured is a concept that includes not only a person but also a dummy head.

As described above, impulse sounds output from the left and right speakers 5L and 5R are measured using the microphones 2L and 2R, respectively, and thereby impulse response is measured. The measurement processor 201 stores the sound pickup signals acquired by the impulse response measurement into a memory or the like. The spatial acoustic transfer characteristics Hls between the left speaker 5L and the left microphone 2L, the spatial acoustic transfer characteristics Hlo between the left speaker 5L and the right microphone 2R, the spatial acoustic transfer characteristics Hro between the right speaker 5R and the left microphone 2L, and the spatial acoustic transfer characteristics Hrs between the right speaker 5R and the right microphone 2R are thereby measured. Specifically, the left microphone 2L picks up the measurement signal that is output from the left speaker 5L, and thereby the spatial acoustic transfer characteristics Hls are acquired. The right microphone 2R picks up the measurement signal that is output from the left speaker 5L, and thereby the spatial acoustic transfer characteristics Hlo are acquired. The left microphone 2L picks up the measurement signal that is output from the right speaker 5R, and thereby the spatial acoustic transfer characteristics Hro are acquired. The right microphone 2R picks up the measurement signal that is output from the right speaker 5R, and thereby the spatial acoustic transfer characteristics Hrs are acquired.

Further, the measurement device 200 may generate the spatial acoustic filters in accordance with the spatial acoustic transfer characteristics Hls, Hlo, Hro, and Hrs from the left and right speakers 5L and 5R to the left and right microphones 2L and 2R based on the sound pickup signals. For example, the measurement processor 201 cuts out the spatial acoustic transfer characteristics Hls, Hlo, Hro, and Hrs with a determined filter length. The measurement processor 201 may correct the measured spatial acoustic transfer characteristics Hls, Hlo, Hro, and Hrs.

In this manner, the measurement processor 201 generates the spatial acoustic filter to be used for convolution calculation of the out-of-head localization device 100. As shown in FIG. 1, the out-of-head localization device 100 performs out-of-head localization processing by using the spatial acoustic filters in accordance with the spatial acoustic transfer characteristics Hls, Hlo, Hro, and Hrs between the left and right speakers 5L and 5R and the left and right microphones 2L and 2R. Specifically, the out-of-head localization processing is performed by convolving the spatial acoustic filters to the audio reproduced signals.

The measurement processor 201 performs the same processing on the sound pickup signals that correspond to the respective spatial acoustic transfer characteristics Hls, Hlo, Hro, and Hrs. Specifically, the same processing is performed on each of the four sound pickup signals that correspond to the spatial acoustic transfer characteristics Hls, Hlo, Hro, and Hrs. The spatial acoustic filters that respectively correspond to the spatial acoustic transfer characteristics Hls, Hlo, Hro, and Hrs are thereby generated.

Note that the measurement processor 201 may store data of each of the spatial acoustic transfer characteristics Hls, Hlo, Hro, and Hrs. Here, data of the spatial acoustic transfer characteristics Hls, Hlo, Hro, and Hrs may be data in a time domain or may be data in a frequency domain. For example, the measurement processor 201 performs discrete Fourier transform on the spatial acoustic transfer characteristics in the time domain, thereby calculating frequency-amplitude characteristics (amplitude spectrum) and frequency-phase characteristics (phase spectrum). Further, frequency-amplitude characteristics and frequency-phase characteristics may be calculated by means for converting a discrete signal into a frequency domain such as discrete cosine transform, instead of performing discrete Fourier transform. Instead of the frequency-amplitude characteristics, frequency power characteristics may be used.

To obtain high localization effect, it is preferable to measure the characteristics of a user and generate an out-of-head localization filter. The spatial acoustic transfer characteristics of an individual user are generally measured in a listening room where an acoustic device such as speakers and room acoustic characteristics are in good condition. Thus, a user needs to go to a listening room or arrange a listening room in the user's home or the like. Therefore, there are cases where the spatial acoustic transfer characteristics of an individual user cannot be measured appropriately.

Further, even when a listening room is arranged by placing speakers in a user's home or the like, there are cases where the speakers are placed in an asymmetric position or the acoustic environment of the room is not appropriate for listening to music. In such cases, it is extremely difficult to measure appropriate spatial acoustic transfer characteristics at home.

On the other hand, measurement of the ear canal transfer characteristics of an individual user is performed with a microphone unit and headphones being worn. In other words, the ear canal transfer characteristics can be measured as long as a user is wearing a microphone unit and headphones. Thus, a user does not need to go to a listening room or arrange a large-scale listening room in a user's home. Further, generation of measurement signals for measuring the ear canal transfer characteristics, recording of sound pickup signals and the like can be done using a user terminal such as a smartphone or a PC.

As described above, there are cases where it is difficult to carry out measurement of the spatial acoustic transfer characteristics on an individual user. In view of the above, an out-of-head localization processing system according to this embodiment selects spatial acoustic transfer characteristics of a person being measured who is similar to the user based on measurement results of the ear canal transfer characteristics. That is, the out-of-head localization processing system determines spatial acoustic transfer characteristics suitable for the user based on measurement results of the ear canal transfer characteristics of the individual user. Regarding this point, a known matching method such as the one disclosed in Japanese Unexamined Patent Application Publication No. 2018-191208 can be used. Therefore, descriptions thereof will be omitted.

For example, by performing impulse response measurement on a plurality of persons being measured, a plurality of pieces of preset data can be acquired. Then, one piece of preset data suitable for the user is selected from among the plurality of pieces of preset data. Then a spatial acoustic filter is generated based on the selected preset data (also referred to as selected data). As described above, a person being measured whose ear canal transfer characteristics are similar to those of the user is extracted and a spatial acoustic filter indicating spatial acoustic transfer characteristics of the extracted person being measured is generated.

Further, the measurement is carried out by changing the relative position of the speakers 5L and 5R relative to the person 1 being measured. In this example, the measurement is carried out by changing the position of the speakers 5L and 5R in the vertical direction. For example, a direction horizontal to the height of the ears of the person 1 being measured is defined as a reference position. The reference position is defined as 0°, and an elevation angle of the speakers 5L and 5R is changed in a range from +30° to -30°. Specifically, the measurement is carried out by changing the height of the speakers 5L and 5R in such a way that the direction from the person 1 being measured to the speakers is changed for every 5°. The horizontal direction is defined as 0°, and an upper direction is shown by a positive angle and a lower direction is shown by a negative angle.

Impulse response measurement is carried out a plurality of times for one person 1 being measured. As will be described later, data regarding spatial acoustic transfer characteristics obtained by the measurement in which the position of the sound source (position of the speakers 5L and 5R) is changed from the reference position is stored as correction data. Here, a spectrum indicating the spatial acoustic transfer characteristics at the reference position is defined as a reference spectrum. The reference spectrum includes an amplitude spectrum and a phase spectrum. The reference spectrum is obtained by performing Fast Fourier Transform (FFT) on sound pickup signals. Further, the reference spectrum may be the one obtained by smoothing the amplitude spectrum obtained by FFT.

### (Adjustment of sound source position)

Further, in this embodiment, the user can perform out-of-head localization listening by changing the position of the virtual sound source. For example, the user inputs the position and the angle in the vertical direction of the virtual sound source that he/she wants to listen to in order to change the position of the virtual sound source in the vertical direction. A processing device corrects the spatial acoustic transfer characteristics stored in the database based on the position of the sound source. The out-of-head localization device 100 performs convolution processing using a spatial acoustic filter indicating the corrected spatial acoustic transfer characteristics.

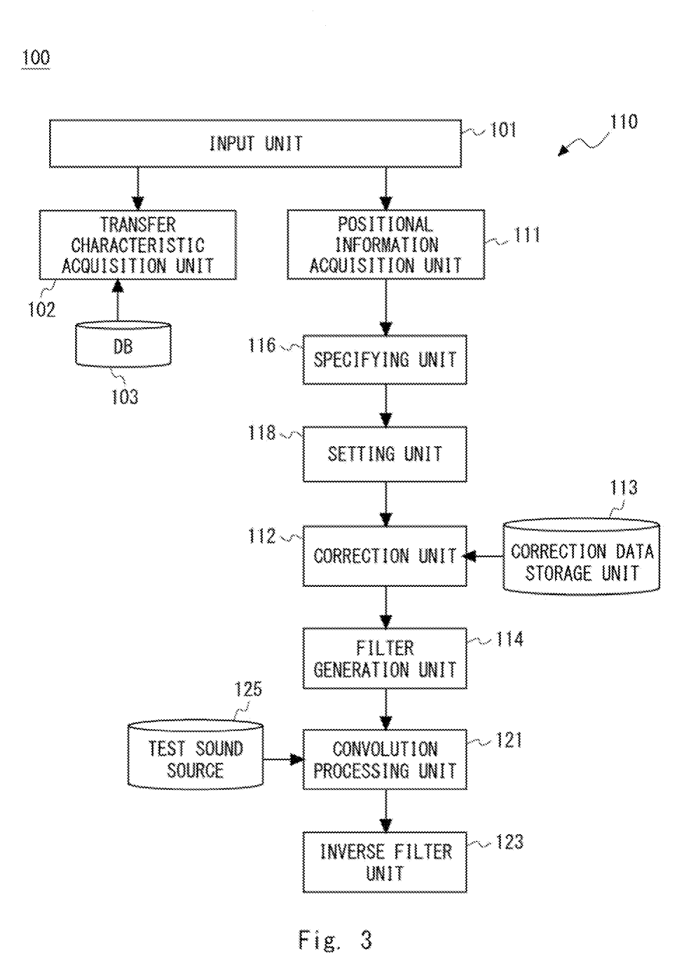

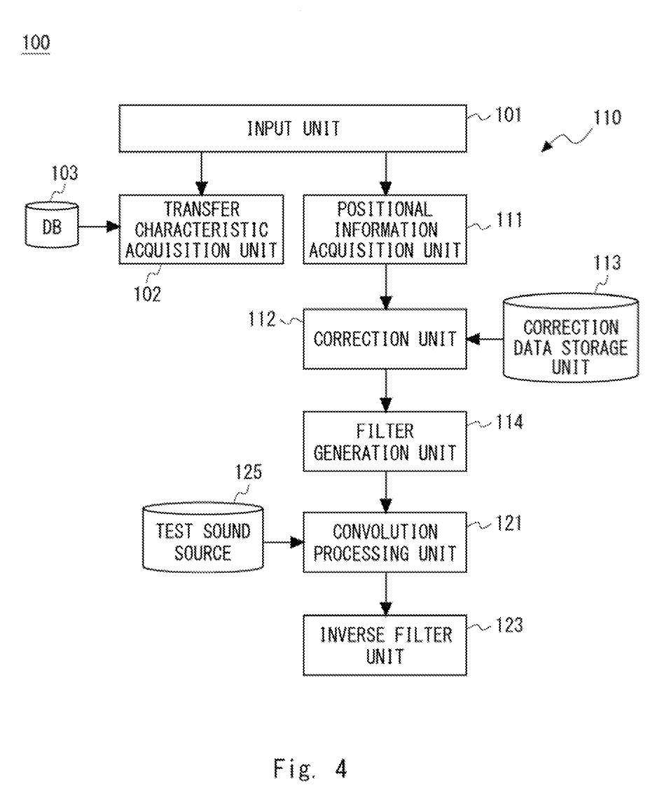

Hereinafter, processing for changing the sound source position in the out-of-head localization processing will be described. FIG. 3 is a block diagram showing a configuration for performing processing to change the sound source position in the out-of-head localization device 100. While similar processing is performed on L-ch and R-ch signals in out-of-head localization processing, as shown in FIG. 1, FIGS. 3 and 4 collectively show L-ch and R-ch processing for the sake of clarification of the description. For example, an inverse filter unit 123 corresponds to the inverse filter units 41 and 42 in FIG. 1. Further, a convolution processing unit 121 corresponds to the out-of-head localization unit 10 shown in FIG. 1.

The out-of-head localization device 100 includes a filter generation device 110, a test sound source 125, a convolution processing unit 121, and an inverse filter unit 123. The filter generation device 110 includes an input unit 101, a transfer characteristic acquisition unit 102, a database 103, a positional information acquisition unit 111, a specifying unit 116, a setting unit 118, a correction unit 112, a correction data storage unit 113, and a filter generation unit 114. Alternatively, the filter generation device 110 includes an input unit 101, a transfer characteristic acquisition unit 102, a database 103, a positional information acquisition unit 111, a correction unit 112, a correction data storage unit 113, and a filter generation unit 114. While the filter generation device 110 is shown as a part of the out-of-head localization device 100, the filter generation device 110 and the out-of-head localization device 100 may be physically separate devices.

The database 103 stores spatial acoustic transfer characteristics Hls, Hlo, Hro, and Hrs from a sound source (speakers 5L and 5R) to the ears 9L and 9R of the user that have been measured in advance. As described above, impulse response measurement is carried out in a state in which the person 1 being measured wears microphones on his/her ears, whereby spatial acoustic transfer characteristics Hls, Hlo, Hro, and Hrs are measured. Data regarding the spatial acoustic transfer characteristics Hls, Hlo, Hro, and Hrs measured in advance is stored in the database 103.

The database 103 stores , as preset data, spatial acoustic transfer characteristics obtained from the measurement on a plurality of persons 1 being measured. The database 103 functions as a preset data storage unit that stores preset data. The database 103 stores data of the spatial acoustic transfer characteristics for each person 1 being measured. In this example, the database 103 stores spatial acoustic transfer characteristics at the reference angle 0°. The database 103 stores four spatial acoustic transfer characteristics at the reference position (0°) for one person being measured. The database 103 may store, as the spatial acoustic transfer characteristics, the spatial acoustic filter itself in a time domain or may store an amplitude spectrum or a phase spectrum in a frequency domain.

The transfer characteristic acquisition unit 102 acquires spatial acoustic transfer characteristics from a sound source to an ear of a person being measured. The transfer characteristic acquisition unit 102 extracts spatial acoustic transfer characteristics from the database 103. The transfer characteristic acquisition unit 102 selects one set of preset data suitable for each of the ears of the user from among a plurality of pieces of preset data. One set of preset data suitable for the left ear includes spatial acoustic transfer characteristics Hls and Hro. One set of preset data suitable for the right ear includes spatial acoustic transfer characteristics Hlo and Hrs. The transfer characteristic acquisition unit 102 extracts preset data including spatial acoustic transfer characteristics Hls, Hlo, Hro, and Hrs. For example, a method using matching of ear canal transfer characteristics may be used, for example, for the extraction of the spatial acoustic transfer characteristics.

Note that the person being measured may be the user U himself/herself. In this case, personal measurement is carried out in a state in which the user U wears microphones on his/her ears, whereby the transfer characteristic acquisition unit 102 can acquire the spatial acoustic transfer characteristics. The spatial acoustic transfer characteristics may be sound pickup signals in a time domain picked up by the microphones or may be frequency characteristics obtained by performing FFT or the like on sound pickup signals.

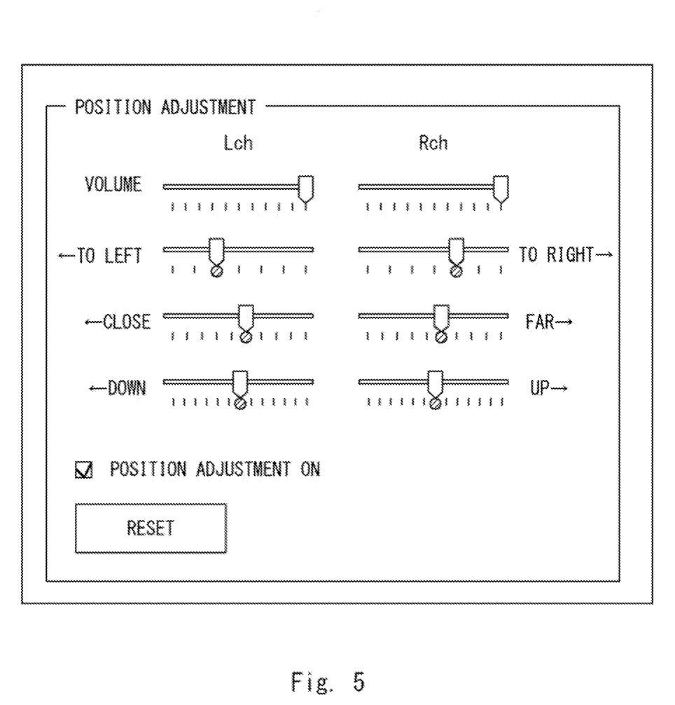

The input unit 101 includes input devices such as a touch panel, a keyboard, and a mouse. The user U can input data by operating the input unit 101. For example, the user U performs input for changing the position of the sound source. FIG. 5 is a diagram showing a Graphical User Interface (GUI) of an input window displayed on a display screen of the out-of-head localization device 100.

FIG. 5 shows respective position adjustment bars for changing the position of the sound source to left/right, front/back, and up/down. FIG. 5 also shows volume adjustment bars. Further, the position adjustment bars and the volume adjustment bar are provided for each of L-ch and R-ch. The user U can adjust the position of the sound source by changing the positions of the position adjustment bars by the input unit 101. The position adjustment can be performed for each of the left and right speakers, independently. When the user U clears the checkbox of position adjustment ON, the position adjustment is ended.

When the user inputs change in the position of the sound source using the input unit 101, the positional information acquisition unit 111 acquires positional information indicating the sound source position. In this example, processing for adjusting the position of the sound source in the vertical direction will be described. For example, when the user U operates the position adjustment bar in the vertical direction, the positional information acquisition unit 111 acquires positional information indicating the position in the vertical direction. The positional information in the vertical direction may be indicated by an elevation angle. Alternatively, the positional information in the vertical direction may be indicated by a height and may be a relative position with respect to a reference height.

The specifying unit 116 specifies peaks and notches in frequency characteristics of the spatial acoustic transfer characteristics. For example, peaks and notches of the frequency-amplitude characteristics are extracted. When the peaks and notches of the frequency-amplitude characteristics are extracted, an outline of an amplitude spectrum obtained by FFT is preferably used.

The specifying unit 116 uses an outline spectrum by performing smoothing processing on the spectral data which is based on the frequency characteristics. The specifying unit 116 smooths the spectral data using a method such as moving average, a Savitzky-Golay filter, smoothing splines, Cepstrum transform, Cepstrum envelope, or the like. Accordingly, the specifying unit 116 can calculate the outline spectrum.

The specifying unit 116 can change the degree of smoothing by giving different values to the order of smoothing. The degree of smoothing becomes low for higher orders, whereas the degree of smoothing becomes high for lower orders. Therefore, spectral data obtained in small-order smoothing processing is smoothed more than spectral data obtained in large-order smoothing processing. The spectral data obtained in the small-order smoothing processing is smoother than the spectral data obtained in the large-order smoothing processing.

The specifying unit 116 obtains an outline spectrum having a small degree of smoothing (this spectrum is also referred to as a first outline spectrum) and an outline spectrum having a large degree of smoothing (this spectrum is also referred to as a second outline spectrum). The specifying unit 116 specifies frequencies of peaks and notches from the second outline spectrum. That is, the outline spectrum having the largest degree of smoothing is used only for specifying frequencies of the peaks and notches. Further, the correction unit 112, the setting unit 118, and the like perform processing that will be described later on the first outline spectrum having a small degree of smoothing.

Hereinafter, unless otherwise specified, the first outline spectrum having a small degree of smoothing is referred to as frequency (amplitude) characteristics or an amplitude spectrum of spatial acoustic transfer characteristics. The correction unit 112, the setting unit 118, and so on perform processing on frequency-amplitude characteristics of spatial acoustic transfer characteristics before smoothing.

Here, in order to distinguish a plurality of notches, the specifying unit 116 specifies these notches as N1, N2, N3, etc. in sequence from the low-frequency side. Likewise, in order to distinguish a plurality of peaks, the specifying unit 116 specifies the peaks as P1, P2, P3, P4, etc. in sequence from the low-frequency side. In frequency-amplitude characteristics of spatial acoustic transfer characteristics in a case where the sound source is located in the front direction of the listener, there are several mountains (peaks) and valleys (notches) that exceed ±10 dB. In particular, notches and peaks are clear to the ear on the side of the sound source. The peak around 4 kHz, which occurs regardless of the direction of the sound source, is defined as a lower-limit frequency, and notches and peaks are labeled toward higher frequencies.

The setting unit 118 sets a shift region in which notches or peaks are shifted. For example, the shift region of the notch N2 is a range including the notch N2. For example, the shift region is defined by an upper-limit frequency and a lower-limit frequency. The processing of the setting unit 118 will be described later. Note that the number of indices for determining the shift region may be set in advance.

The correction unit 112 corrects spatial acoustic transfer characteristics using correction data. The correction unit 112 corrects peaks and notches of the frequency characteristics of the spatial acoustic transfer characteristics in accordance with positional information. The correction unit 112 corrects data of amplitude values which are in the shift region.

Specifically, the correction unit 112 corrects spatial acoustic transfer characteristics based on positional information in the vertical direction. Accordingly, the spatial acoustic transfer characteristics acquired by the transfer characteristic acquisition unit 102 are corrected. Further, the correction unit 112 corrects spatial acoustic transfer characteristics by referring to correction data stored in the correction data storage unit 113. For example, the correction data includes the frequency and the amplitude of each of the peaks of the frequency-amplitude characteristics, and the frequency and the amplitude of each of the notches of the frequency-amplitude characteristics.

In this embodiment, the frequency-amplitude characteristics of the peaks and notches are indicated by an Index value in the FFT analysis width. When the sampling frequency is denoted by Fs, frequency [Hz] = Index value*Fs/(FFT analysis width). For example, when FFT is performed under conditions of the sampling frequency: 48 kHz and the FFT analysis width (Length): 2048 points, then the frequency increases by about 23.44 Hz each time the Index value increases by 1. When the Index value is 111, the frequency is 2601.1 Hz. Note that the frequency-amplitude characteristics may be indicated by a frequency [Hz], not by an Index value.

The correction data storage unit 113 stores correction data used for correction. The correction data storage unit 113 stores data of peaks and notches of spatial acoustic transfer characteristics measured by changing the position in the vertical direction. Further, the correction data includes data regarding peaks and notches for each person 1 being measured. The correction using the correction data will be described later. The correction unit 112 outputs the corrected spatial acoustic transfer characteristics to the filter generation unit 114.

The filter generation unit 114 generates a spatial acoustic filter based on the corrected spatial acoustic transfer characteristics. The corrected spatial acoustic transfer characteristics are based on spatial acoustic transfer characteristics from the changed position of the virtual sound source in the vertical direction to the ears. It is therefore possible to form sound images localized at the position in the vertical direction by using the corrected spatial acoustic filter (correction filter). The filter generation unit 114 generates a spatial acoustic filter in accordance with the corrected spatial acoustic transfer characteristics as a correction filter.

The test sound source 125 stores reproduced signals for previewing (the reproduced signals are also referred to as test signals). Therefore, the user U can adjust the position of the virtual sound source while listening to the test signals. That is, the user U listens to the reproduced signals of the test sound source 125 while adjusting the position of the sound source. The user U can adjust the position of the virtual sound source at a position where the localization effect is high. As described above, the sound localization position can be adjusted in accordance with the preference of the user U.

The convolution processing unit 121 convolves the correction filter into the reproduced signals of the test sound source 125. The convolution processing unit 121, which corresponds to the out-of-head localization unit 10 in FIG. 1, includes four convolution calculation units and two adders. The convolution processing unit 121 convolves the correction filter into L-ch and R-ch input signals. As shown in FIG. 1, a spatial acoustic filter indicating spatial acoustic transfer characteristics Hls, Hlo, Hro, and Hrs from the sound source after position adjustment to the ears is set in the convolution processing unit 121. Then the convolution processing unit 121 adds the two signals and outputs the obtained signal to the inverse filter unit 123.

The inverse filter unit 123 convolves the inverse filter into a signal into which the correction filter is convolved. The inverse filter unit 123 corresponds to the inverse filter units 41 and 42 shown in FIG. 1. Therefore, a signal into which the inverse filters Linv and Rinv are convolved is output from the headphones 43. Since the processing in the convolution processing unit 121 and the inverse filter unit 123 is similar to that in FIG. 1, descriptions thereof will be omitted.

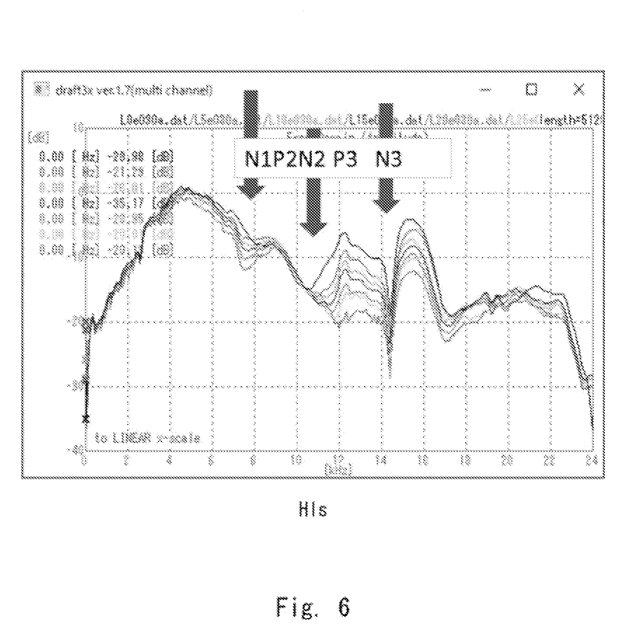

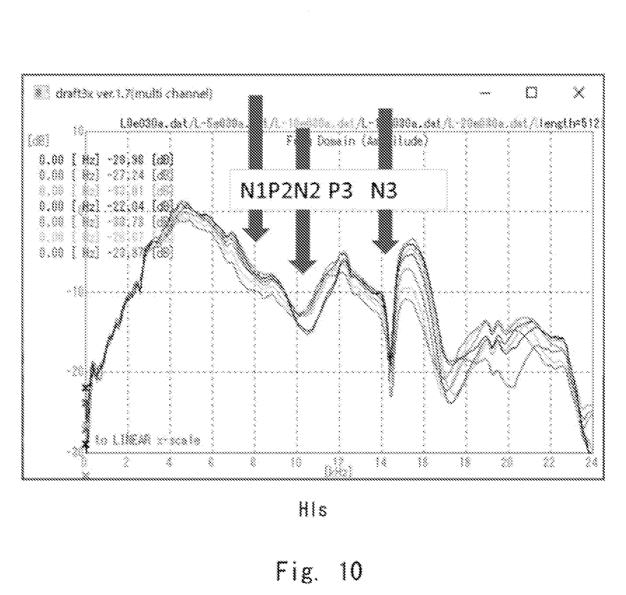

FIGS. 6-13 are graphs each showing frequency-amplitude characteristics (amplitude spectrum) based on measurement data for one person 1 being measured. The horizontal axis indicates the frequency [Hz] and the vertical axis indicates the amplitude [dB]. FIGS. 6-9 are graphs each showing the amplitude spectrum in a case where the sound source position is raised for every 5° in a range from 0° to +30°. FIGS. 10-13 are graphs each showing the amplitude spectrum in a case where the sound source position is lowered for every 5° in a range from -30° to 0°.

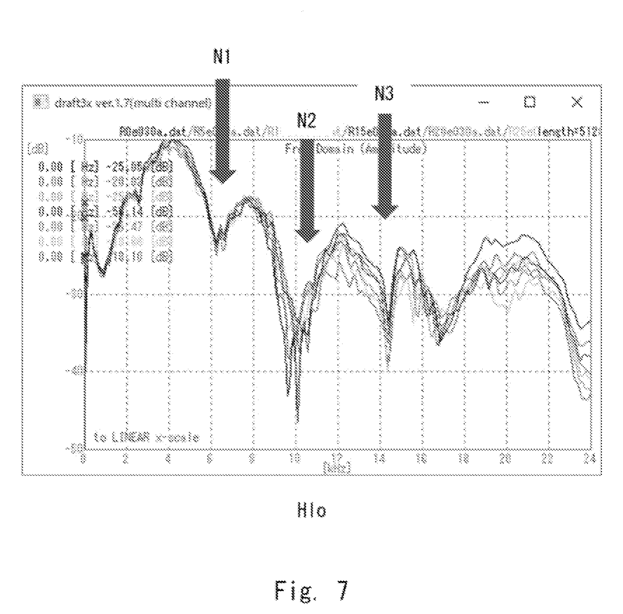

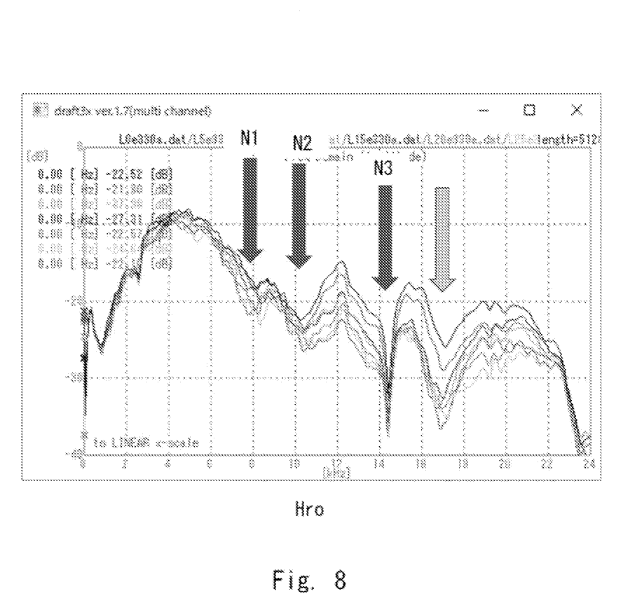

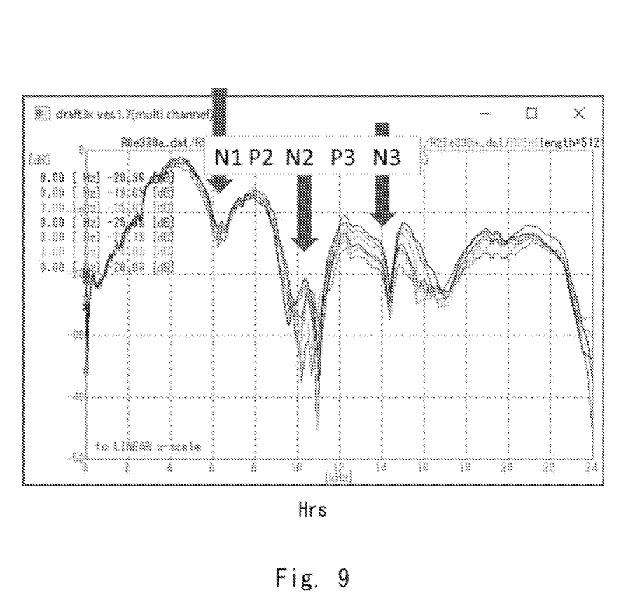

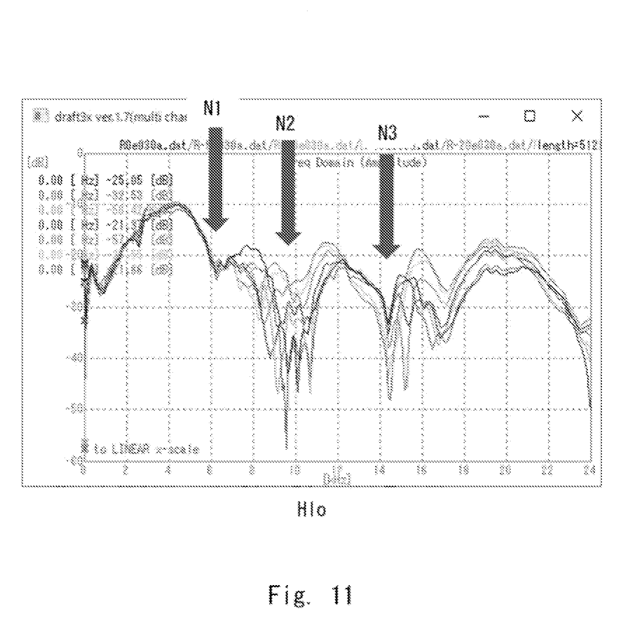

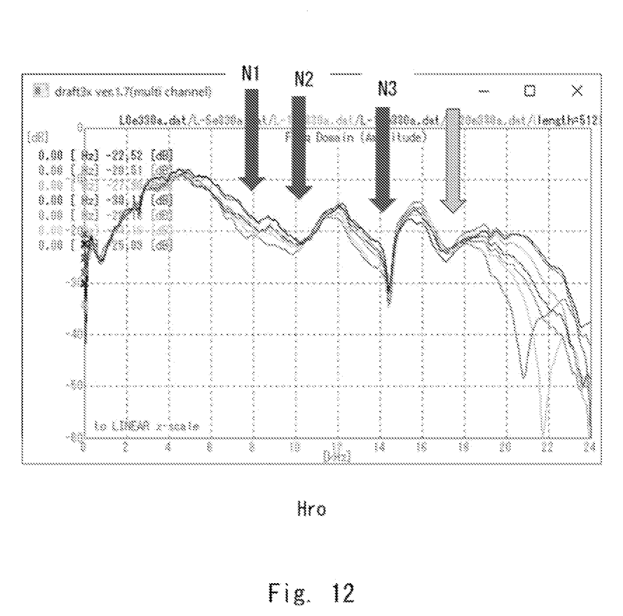

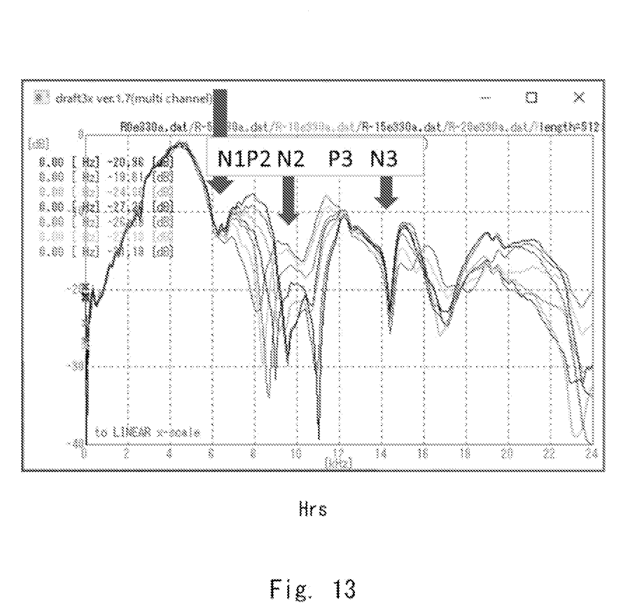

FIGS. 6 and 10 each show the amplitude spectrum of the spatial acoustic transfer characteristics Hls. FIGS. 7 and 11 show the amplitude spectrum of the spatial acoustic transfer characteristics Hlo. FIGS. 8 and 12 each show the amplitude spectrum of the spatial acoustic transfer characteristics Hro. FIGS. 9 and 13 each show the amplitude spectrum of the spatial acoustic transfer characteristics Hrs.

As shown in FIGS. 6-13, each amplitude spectrum includes a plurality of peaks and a plurality of notches. As shown in FIGS. 6-13, peaks and notches are shifted in accordance with the sound source position. The out-of-head localization device 100 or the measurement device 200 extracts peaks and notches of the amplitude spectrum. Then the correction data storage unit 113 stores correction data for correcting peaks and notches. The correction data will be described later.

Here, in order to distinguish a plurality of notches, these notches are specified as N1, N2, N3, etc. in sequence from the low-frequency side. Likewise, in order to distinguish a plurality of peaks, these peaks are specified as P1, P2, P3, etc. in sequence from the low-frequency side. Note that frequency bands in which peaks and notches are extracted in FIGS. 6-13 may be some bands of the amplitude spectrum. That is, it is sufficient that peaks and notches be extracted only for a band where correction needs to be performed. For example, in FIG. 6 and so on, only the notches N1-N3 and the peaks P2 and P3 are extracted. Therefore, since the peak P1 is outside the band where correction needs to be performed, the peak P1 is not clearly shown in FIG. 6.

When peaks and notches of the frequency-amplitude characteristics are extracted, it is preferable that the outline of the amplitude spectrum obtained by FFT is used. For example, the measurement device 200 obtains the outline of the amplitude spectrum (outline spectrum) by smoothing the amplitude spectrum by spline interpolation, moving average, or the like. Then the measurement device 200 detects local maximum values of the outline spectrum as peaks and detects local minimum values thereof as notches.

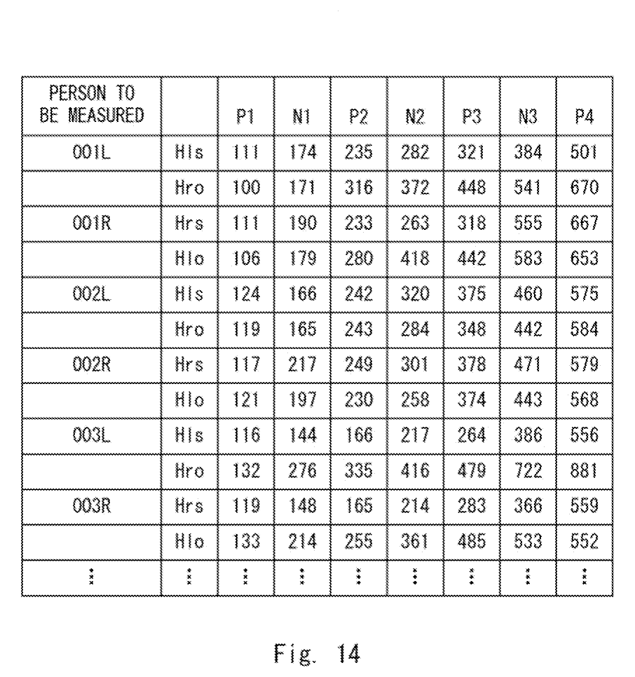

FIG. 14 shows a peak notch table obtained by carrying out measurement on a plurality of persons 1 being measured. FIG. 14 is a peak notch table (this table is also referred to as a frequency table) showing frequencies of the peaks P1-P4 and the notches N1-N3. Specifically, FIG. 14 shows Index values corresponding to the frequencies of the peaks P1-P4 and the notches N1-N3.

FIG. 14 shows measurement data when the position of the sound source is at the reference position, that is, 0°. In FIG. 14, 001L and 001R respectively show data regarding left and right ears of a first person 1 being measured. Regarding the left ear, peaks and notches of the spatial acoustic transfer characteristics Hls and Hro are included. Regarding the right ear, peaks and notches of the spatial acoustic transfer characteristics Hrs and Hlo are included.

Likewise, 002L and 002R shown in FIG. 14 respectively show data regarding left and right ears of a second person 1 being measured, and 003L and 003R respectively show data regarding left and right ears of a third person 1 being measured. For each of the persons 1 being measured, data of the frequencies of the peaks and notches is stored. Further, a peak notch table (this table is also referred to as an amplitude table) indicating amplitude values (amplitude levels) of the peaks and notches is obtained. That is, for one sound source position, two tables: a frequency table and an amplitude table, are obtained. Further, for each sound source position, the frequency table and the amplitude table are obtained.

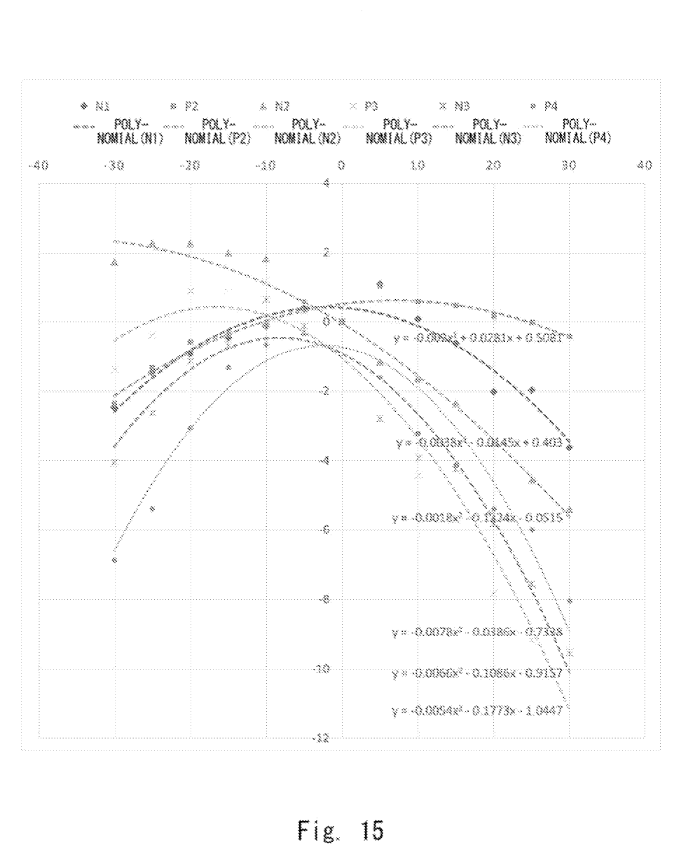

FIG. 15 is a graph showing transition of the amplitude level for each peak and for each notch. The horizontal axis in FIG. 15 indicates the angle of the sound source (the position in the vertical direction) and the vertical axis in FIG. 15 indicates the amplitude level of the peak or the notch. As described above, data in a case where the position in the vertical direction is changed for every 5° in a range from -30° to +30° is obtained. As the position of the sound source is changed in the vertical direction, the amplitude levels of the peaks and notches are changed.

FIG. 15 shows a polynomial obtained by approximating data of an amplitude level for each peak and for each notch. In this example, the amplitude level is approximated by a second-order polynomial. For example, for the notch N1, the amplitude level at the time when the position in the vertical direction is changed is subjected to a polynomial approximation. FIG. 15 also shows each of a polynomial obtained by approximating the notch N2 and a polynomial obtained by approximating the amplitude level of the notch N3. FIG. 15 shows each of a polynomial obtained by approximating the amplitude level of the peak P2, a polynomial obtained by approximating the amplitude level of the peak P3, and a polynomial obtained by approximating the amplitude level of the peak P4.

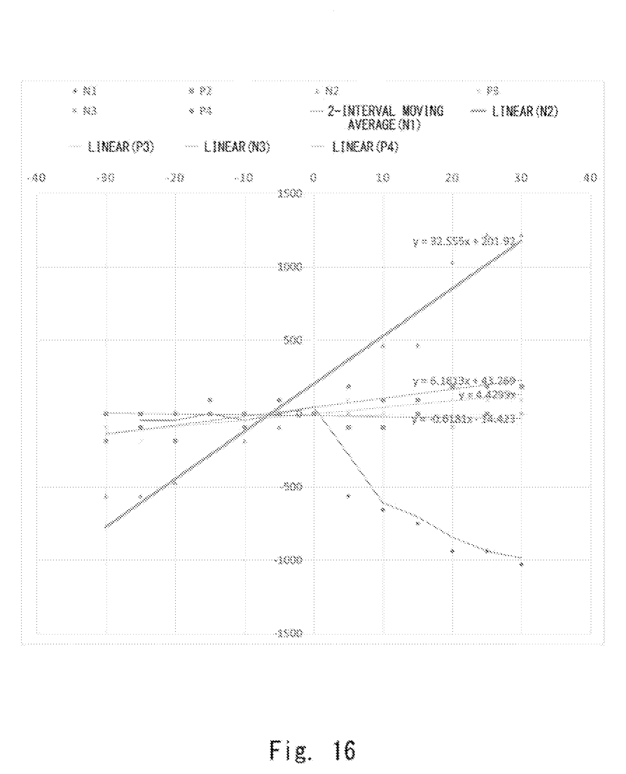

FIG. 16 is a graph showing transition of the frequency for each peak and for each notch. The horizontal axis in FIG. 16 indicates the position in the vertical direction and the vertical axis in FIG. 16 indicates the frequency of the peak or the notch. As described above, data in a case where the position in the vertical direction is changed for every 5° in a range from -30° to +30° is obtained. As the position of the sound source is changed in the vertical direction, the frequencies of the peaks and notches are changed.

FIG. 16 shows a polynomial obtained by approximating data of the frequency for each peak and for each notch. In this example, the frequency is approximated by a first-order polynomial. For example, for the notch N3, the frequency at the time when the position in the vertical direction is changed is subjected to a linear approximation. Likewise, FIG. 16 shows each of the expression obtained by performing the linear approximation on the frequency of the peak P3 and the expression obtained by performing the linear approximation on the frequency of the peak P4.

The correction data may be the peak notch table as shown in FIG. 14. Alternatively, the correction data includes data of a polynomial obtained by approximating the amplitude and the frequency. For example, the correction data storage unit 113 may use coefficients of the polynomial as the correction data. Therefore, the correction data storage unit 113 stores each of coefficients of the polynomial for each notch and for each peak. As a matter of course, the approximation is not limited to a linear approximation or a second-order polynomial approximation, and various approximate expressions may be used. Preferably, the correction data is in a form of a calculation formula for obtaining shift amounts. For example, the correction data may be a calculation formula obtained from the peak notch table of the person being measured. The correction data storage unit 113 stores data of a calculation formula for each peak and a calculation formula for each notch. The correction unit 112 calculates a shift amount by inputting the positional information (angle) in the vertical direction into the calculation formula. Then the correction unit 112 shifts the peak or the notch by the shift amount.

The correction unit 112 corrects peaks and notches of the spatial acoustic transfer characteristics by referring to the correction data stored in the correction data storage unit 113. That is, the correction unit 112 moves peaks and the notches at the amplitude spectrum according to the position after the adjustment. Accordingly, the position of the sound source can be changed to a desired position. For example, the user U changes the position of the virtual sound source by operating the input unit 101. While an example in which the user U changes the position of the virtual sound source to +10° will be described in this example, the position is not limited to +10.

The correction unit 112 obtains a shift amount of a peak and a notch between the amplitude spectrum (reference spectrum) at the reference position (0°) and the amplitude spectrum at +10°. The shift amount corresponds to a difference between two spectra. For example, the correction unit 112 calculates the frequency and the amplitude of the peak and the notch at the reference position by referring to the approximate expression of the correction data. The correction unit 112 calculates the frequency and the amplitude of the peak and the notch at +10° by referring to the approximate expression of the correction data. The correction unit 112 calculates the frequency and the amplitude for each peak and for each notch.

For each of the notches, the difference in the amplitude and the difference in the frequency are obtained between two spectra. The correction unit 112 shifts the notch of the reference spectrum according to these differences. Specifically, the correction unit 112 calculates a frequency difference value and an amplitude difference value between the notch N2 of the reference spectrum and the notch N2 of the spectrum at +10°. Likewise, the correction unit 112 may calculate the frequency difference value and the amplitude difference value for each of the notches N1 and N3, the peak P2, and the like.

The correction unit 112 shifts each of the frequency and the amplitude for each notch by referring to the correction data. Accordingly, the notch in the reference spectrum is shifted. The correction unit 112 shifts each of the frequency and the amplitude for each peak by referring to the correction data. Accordingly, the peak in the reference spectrum is shifted. Accordingly, the correction spectrum is obtained by shifting the peak and the notch.

As can be seen in FIG. 16, the frequency of the notch N2 is greatly changed according to the vertical position of the sound source. In this embodiment, the correction unit 112 corrects the frequency and the amplitude level of the notch N2. Specifically, when the sound source position is adjusted downward, the frequency of the notch N2 is shifted toward the low-frequency side. When the sound source position is adjusted upward, the frequency of the notch N2 is shifted toward the high-frequency side.

The amplitude levels of the notches N1 and N3 and the peaks P2-P4 are changed according to the vertical position of the sound source. Therefore, the correction unit 112 preferably corrects the amplitude level of the notch N1. Further preferably, for the notch N3 and the peaks P2 and P3, the correction unit 112 corrects the amplitude level. The amplitude levels of the notches N1 and N3 and the peaks P2-P4 are changed. Therefore, the correction unit 112 may not correct the frequencies of the notches N1 and N3 and the peaks P2-P4.

As described above, the specifying unit 116 specifies the frequencies of the peaks P1-P4 and the notches N1-N4 of the amplitude spectrum. For example, the specifying unit 116 obtains a second outline spectrum by smoothing the spectrum after FFT. Then the specifying unit 116 detects the local maximum value of the second outline spectrum as a peak frequency and detects the local minimum value as a notch frequency. With this procedure, the specifying unit 116 specifies the notch N2 which is on the second from the low-frequency side.

The specifying unit 116 may specify peaks and notches in advance before the transfer characteristic acquisition unit 102 acquires spatial acoustic transfer characteristics. For example, peaks and notches of the amplitude spectrum are specified in advance for all the spatial acoustic transfer characteristics stored in the database 103 in advance. The specifying unit 116 may add data showing the frequencies of the peaks and notches to the spatial acoustic transfer characteristics.

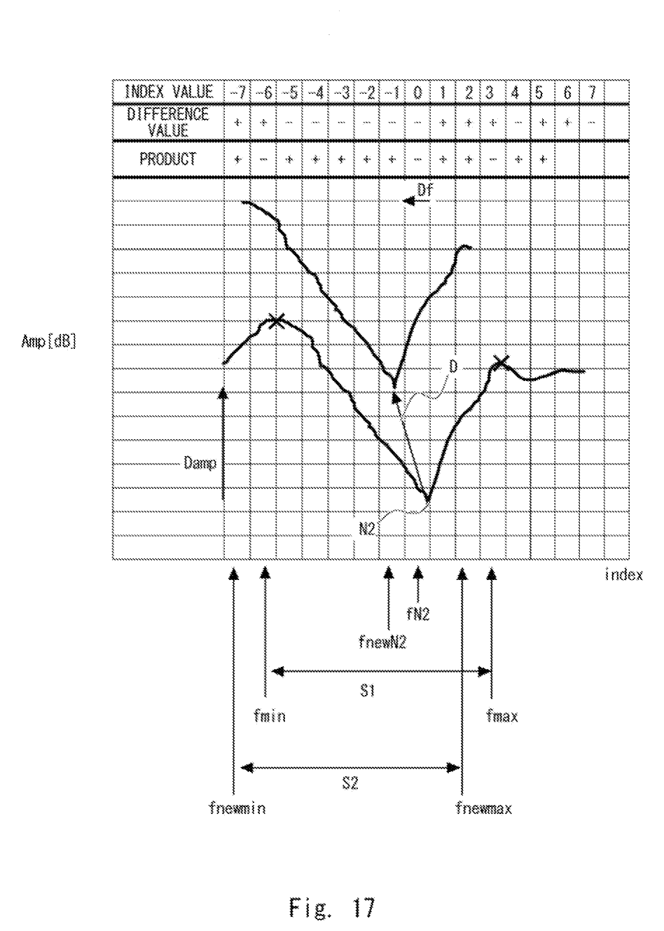

With reference to FIG. 17, processing in the setting unit 118 and the correction unit 112 will be described. FIG. 17 is a diagram for describing a shift region for correcting the notch N2, and schematically shows an amplitude spectrum (first outline spectrum) at the reference angle.

More specifically, FIG. 17 is a graph showing an enlarged view of the reference spectrum around the notch N2. In FIG. 17, the horizontal axis indicates the Index value of the frequency, and the vertical axis indicates the amplitude level. In this example, it is assumed that an Index value of a frequency fN2 of the notch N2 is 0, which is a reference, and the Index value increases toward the high-frequency side and the Index value decreases toward the low-frequency side.

The setting unit 118 sets the shift region S1 of the notch N2 in the amplitude spectrum. The shift region S1 is a region including the notch N2. Specifically, the shift region S1 is a frequency range (band) defined by a lower-limit frequency fmin which is lower than the frequency of the notch N2 and an upper-limit frequency fmax which is higher than the frequency of the notch N2. Each of fmin, fmax, and fN2 is a frequency indicated by an Index value.

The setting unit 118 calculates the upper-limit frequency fmax and the lower-limit frequency fmin by obtaining extreme values of the amplitude spectrum (first outline spectrum). For example, the setting unit 118 calculates the upper-limit frequency fmax and the lower-limit frequency fmin based on a slope of the amplitude spectrum. The slope corresponds to a difference value of amplitude values adjacent to each other. FIG. 17 shows the sign of the slope (difference value) in each Index value. FIG. 17 also shows the sign of the product of two difference values that are adjacent to each other. The sign of the difference value and the slope is shown by positive (+) or negative (-). Preferably, the spectrum for obtaining extreme values is a first outline spectrum.

When difference values indicate the same sign in two Index values adjacent to each other, the product becomes positive. For example, when the sign of the difference values is positive in two Index values adjacent to each other, the product becomes positive. When the sign of the difference values is negative in two Index values adjacent to each other, the product becomes positive. When difference values indicate different signs in two Index values adjacent to each other, the product becomes negative. For example, when the sign of one difference value is positive and the sign of the other difference value is negative in two Index values adjacent to each other, the product becomes negative.

As shown in FIG. 17, a product of difference values becomes negative in extreme values. The setting unit 118 obtains the local maximum value that is the closest to the notch N2 on each of the low-frequency side and the high-frequency side of the notch N2. That is, the extreme value that is the closest to the notch N2 on the high-frequency side of the notch N2 is set as an upper-limit frequency fmax. The setting unit 118 sets the extreme value that is the closest to the notch N2 on the low-frequency side as a lower-limit frequency fmin. The setting unit 118 sets a range from the lower-limit frequency fmin to the upper-limit frequency fmax as the shift region S1. The number of indices included in the shift region S1 is indicated by the difference between fmax and fmin (fmax-fmin).

As shown in FIG. 17, the correction unit 112 shifts data included in the shift region S1 by a shift amount D. The shift amount D includes a frequency difference value Df and an amplitude difference value Damp.

Therefore, the shift amount D is shown by a two-dimensional vector (Df, Damp). The correction unit 112 moves the data in the shift region S1 by the frequency difference value Df along the horizontal axis. The frequency difference value Df is shown by the number of indices, that is, by an integer. Likewise, the correction unit 112 moves the data in the shift region S1 by the amplitude difference value Damp along the vertical axis.

The data after shifting is denoted by shift data S2. The shift data S2 is a range defined by a lower-limit frequency fnewmin and an upper-limit frequency fnewmax. fnewmin = fmin-Df and fnewmax = fmax-Df. Here, Df is a positive integer indicating the number of indices. When the frequency of the notch N2 after shifting is denoted by fnewN2, fnewN2 = fN2-Df is established. Each of fnewmin, fnewmax, and fnewN2 is a frequency indicated by the Index value.

Since the correction unit 112 sets the shift region S1, the spectrum waveform in the vicinity of the notch N2 is parallel translated as it is. The spectrum waveform in the shift data S2 matches the spectrum waveform in the shift region S1. The notch N2 can be moved while maintaining the shape in the vicinity of the notch N2. In this manner, the correction unit 112 sets the shift region S1 including the notch N2. Then, the data included in the shift region S1 is shifted by the shift amount D. With this procedure, the correction unit 112 can perform correction while maintaining the waveform shape (shape of the amplitude spectrum) around the notch in the reference spectrum. Accordingly, even when the virtual sound source is at a desired position, the spatial acoustic filter can be appropriately corrected. It is therefore possible to appropriately perform out-of-head localization processing.

In this example, the data in the shift region S1 is parallel translated to the low-frequency side (the left side in FIG. 17) and the high-level side (the upper side in FIG. 17). The number of indices included in the shift region S1 is equal to the number of indices included in the shift data S2. For frequencies other than the shift data S2, the correction unit 112 can use the amplitude levels that have not been shifted. That is, for the outside the shift data S2, the correction unit 112 may not correct amplitude levels.

For the peak P2, the peak P3, the notch N1, and the notch N3, the correction unit 112 changes only amplitude levels. That is, for the peak P2, the peak P3, the notch N1, and the notch N3, the correction unit 112 does not shift peak frequencies and notch frequencies. Specifically, the correction unit 112 acquires an amplitude difference value Damp based on the positional information. In other words, for the peaks P2 and P3 and the notches N1 and N3, the frequency difference value Df = 0. That is, the correction unit 112 shifts the peak P2, the peak P3, the notch N1, and the notch N3 only in the vertical direction.

When the sound source position is shifted upward, as shown in FIG. 16, the peak frequency of the notch N1 is shifted downward. Therefore, for the notch N1, the notch frequency may be shifted, like for the notch N2. For the peak P2, the peak P3, the notch N1, and the notch N3, the setting unit 118 may set the shift region, like for the notch N1. That is, the setting unit 118 may set the shift region based on extreme values on both sides of the peak or the notch. Alternatively, for the peak P2, the peak P3, the notch N1, and the notch N3, the number of indices to be in the shift region may be set in advance.

Further, the correction unit 112 performs data interpolation on both ends of the shift data S2. Accordingly, a discontinuous shape of the amplitude spectrum after shifting can be corrected. Specifically, on each of both ends of the shift data, the correction unit 112 sets an interpolation range in which amplitude levels are interpolated. The correction unit 112 calculates the amplitude level by the data interpolation in the interpolation range. The correction unit 112 can perform correction in such a way that an amplitude level does not change rapidly.

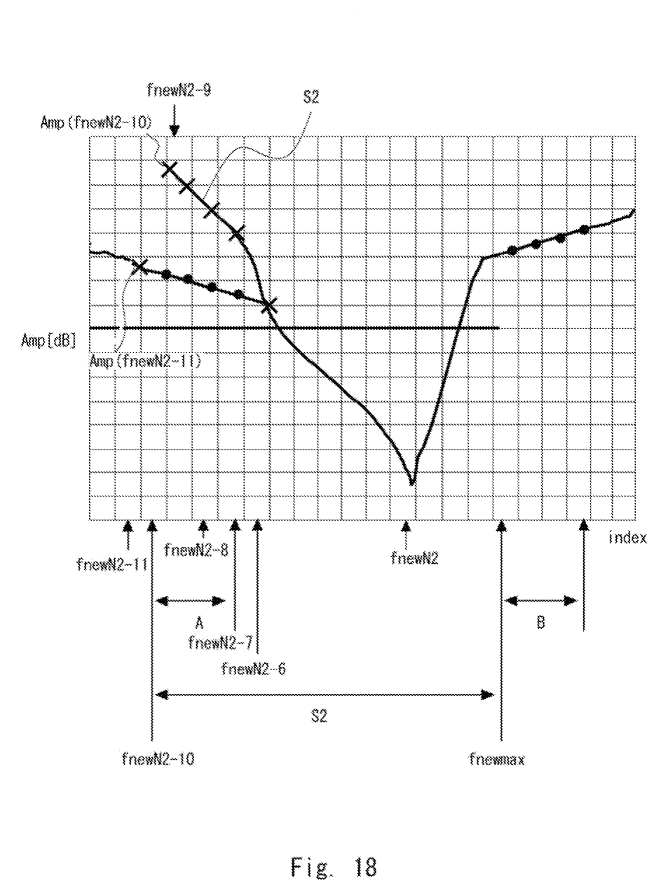

With reference to FIG. 18, this interpolation processing will be described. FIG. 18 is a graph schematically showing amplitude spectra before and after interpolation. FIG. 18 is a diagram showing an example in which the notch N2 is shifted upward. FIG. 18 shows an amplitude spectrum around the notch N2. The horizontal axis indicates the Index value and the vertical axis indicates the amplitude level. In this example, processing for interpolating data of the notch N2 on the low-frequency side will be mainly described.

Here, the Index value of the notch frequency after shifting is given by fnewN2. Further, the Index value of the lower-limit frequency fnewmin of the shift data S2 is given by (fnewN2-10). Further, the amplitude level of the shift data S2 at the lower-limit frequency is given by Amp(fnewN2-10). Further, the Index value which is smaller than the lower-limit frequency (fnewN2-10) by one is given by (fnewN2-11). The amplitude level of the reference spectrum in (fnewN2-11) is given by Amp(fnewN2-11). Amp(fnewN2-11) is an amplitude level in the reference spectrum. The Index value which is larger than the lower-limit frequency (fnewN2-10) by one is given by (fnewN2-9), or the like, and the amplitude level thereof is given by Amp(fnewN2-9), or the like. Amp(fnewN2-11) is an amplitude level after shifting.

Here, Amp(fnewN2-11) is smaller than Amp(fnewN2-10). Likewise, Amp(fnewN2-11) is smaller than Amp(fNewN2-9) to Amp(fNewN2-7). Amp(fnewN2-11) is larger than Amp(fNewN2-6). Therefore, the correction unit 112 performs data interpolation for a range from (fnewN2-10) to (fnewN2-7), which is an interpolation range A.

The correction unit 112 compares two amplitude levels in the boundary between the frequency at which data is not corrected and the frequency at which data is corrected. The correction unit 112 sets the interpolation range A based on the result of comparing the amplitude levels. The correction unit 112 compares the amplitude level after shifting with the amplitude level at the frequency at which data is not corrected. The frequency at which data is not corrected is a frequency which is the closest to the notch N2 in a frequency band in which data is not corrected.

In FIG. 18, the frequency at which data is not corrected is (fnewN2-11) and its amplitude level is Amp(fnewN2-11). The correction unit 112 incorporates a frequency at which the amplitude level after shifting exceeds the amplitude level Amp(fnewN2-11) into the interpolation range A. The correction unit 112 searches for frequencies whose amplitude levels become smaller than Amp(fnewN2-11) from the lower-limit frequency of the shift data in sequence. The frequencies (fnewN2-10) to (fnewN2-7) whose amplitude levels become larger than Amp(fnewN2-11) are defined as an interpolation range A. Accordingly, the correction unit 112 can perform correction in such a way that the amplitude spectrum becomes smooth in the interpolation range A.

For data on the high-frequency side, an interpolation range B is set. In FIG. 18, the interpolation range B is given by (fnewN2+4) to (fnewN2+7). The correction unit 112 calculates amplitude values in the interpolation range B by interpolation processing. The correction unit 112 calculates the amplitude levels of (fnewN2+4) to (fnewN2+7) by interpolation processing that uses Amp(fnewN2+3) and Amp(fnewN2+8).

As described above, the correction unit 112 corrects data in such a way that the amplitude level at the frequency at which data is corrected does not exceed the amplitude level at the frequency at which data is not corrected. The correction unit 112 can perform correction in such a way that extreme values are not formed in the vicinity of the boundary between the frequency at which data is corrected and the frequency at which data is not corrected. As a matter of course, the number of indices in the interpolation range A on the low-frequency side and that in the interpolation range B on the high-frequency side may be the same or different from each other. The correction unit 112 can calculate the interpolation ranges A and B based on the frequency difference value and the amplitude value.

In this example, the correction unit 112 calculates the amplitude levels in (fnewN2-10) to (fnewN2-7) by performing linear interpolation using the amplitude levels of Amp(fnewN2-11) and Amp(fnewN2-6). When, for example, the amplitude level after the interpolation in (fnewN2-10) is given by Ampint(fnewN2-10), Ampint(fnewN2-10) is a value smaller than Amp(fnewN2-11) but is larger than Amp(fnewN2-6). As a matter of course, the correction unit 112 may perform interpolation using a quadratic curve or the like, not the linear interpolation.

Note that the interpolation ranges A and B may be inside or outside the frequency range fnewmin-fnewmax of the shift data S2. Alternatively, the interpolation range A may be set so as to include the lower-limit frequency fnewmin of the shift data S2. The interpolation range B may be set so as to include the upper-limit frequency fnewmax of the shift data S2.

The correction unit 112 sets the interpolation ranges A and B in the vicinity of the end parts of the shift data S2. The correction unit 112 calculates the amplitude levels of the interpolation ranges A and B by interpolating the amplitude levels outside the interpolation ranges A and B. The correction unit 112 corrects data so that the amplitude levels become continuous in the interpolation range A. The correction unit 112 corrects data so that the amplitude levels become continuous in the interpolation range B. It is possible to prevent new extreme values from being formed on both ends of the shift data S2. That is, it is possible to prevent (fnewN2-10) to (fnewN2-7) from being the local maximum values in FIG. 18. Since it is possible to prevent the number of extreme values from increasing, the original shape of the amplitude spectrum can be maintained. The correction unit 112 can perform more appropriate correction.

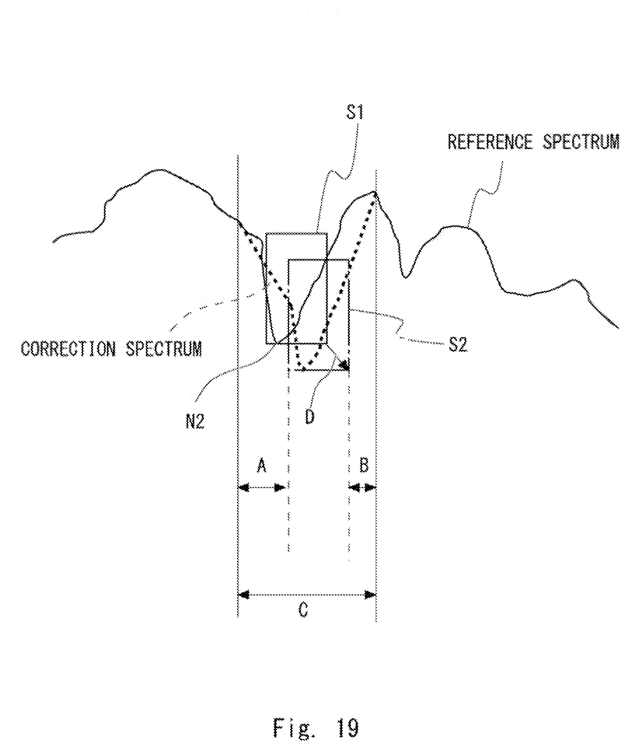

With reference to FIG. 19, another processing in the correction unit 112 will be described. FIG. 19 is a diagram for describing processing for correcting a notch N2, and schematically shows an amplitude spectrum (reference spectrum). First, the correction unit 112 sets a shift region S1 of the notch N2 in the reference spectrum. The shift region S1 is a region including the notch N2. Specifically, the shift region S1 is a frequency range (band) defined by a lower-limit frequency which is lower than the frequency of the notch N2 and an upper-limit frequency which is higher than the frequency of the notch N2. For example, the number of pieces of data (the number of indices) to be in the shift region S1 may be set in advance in the correction unit 112. Alternatively, the correction unit 112 may set the shift region S1 according to the shift amount D or the like.

The correction unit 112 shifts the data included in the shift region S1 by a shift amount D. The shift amount D includes a frequency difference value and an amplitude difference value. The correction unit 112 moves the data in the shift region S1 by the frequency difference value along the horizontal axis. Likewise, the correction unit 112 moves the data in the shift region S1 by the amplitude difference value along the vertical axis. In this example, the data in the shift region S1 is parallel translated in the high-frequency side (the right side in FIG. 19) and the low-level side (lower side in FIG. 19).

The data after shifting is denoted by shift data S2. Since the shift region S1 is set, a spectrum waveform in the vicinity of the notch N2 is parallel translated as it is. The spectrum waveform in the shift data S2 matches the spectrum waveform in the shift region S1. The notch can be moved while maintaining the shape in the vicinity of the notch. In this manner, the correction unit 112 sets the shift region S1 including the notch. Then, data included in the shift region S1 is shifted by the shift amount D. With this procedure, the correction unit 112 can perform correction while maintaining the waveform shape (shape of the amplitude spectrum) around the notch in the reference spectrum. Accordingly, even when the virtual sound source is set at a desired position, the spatial acoustic filter can be appropriately corrected. Accordingly, out-of-head localization processing can be appropriately performed.

The correction unit 112 further sets a correction range C. The correction range C is a frequency range wider than the shift region S1. The correction range C is a range including the shift region S1 and the shift data S2. In the correction range C, ranges outside the range of the shift data S2 are interpolation ranges A and B. In this example, a range from the lower-limit frequency of the correction range C to the lower-limit frequency of the shift data S2 is the interpolation range A. A range from the upper-limit frequency of the correction range C to the upper-limit frequency of the shift data S2 is the interpolation range B. The number of pieces of data (the number of indices) to be in the correction range C may be set in advance in the correction unit 112. Alternatively, the correction unit 112 may set the correction range C in accordance with the shift amount D.

The correction unit 112 generates data in the interpolation ranges A and B by data interpolation. Specifically, amplitude levels of the interpolation ranges A and B are calculated using, for example, linear interpolation or polynomial interpolation. The correction unit 112 preferably uses polynomial interpolation such as spline interpolation. The correction unit 112 calculates amplitude values in the interpolation ranges A and B by performing data interpolation.

As described above, the correction unit 112 sets the interpolation ranges A and B around the shift data S2. Then, in the interpolation range A, data interpolation is performed so as to connect the amplitude level of the reference spectrum to the amplitude level of the shift data S2. With this procedure, the correction unit 112 can perform correction in such a way that the amplitude level becomes smooth in the interpolation ranges A and B.

As described above, the correction unit 112 generates amplitude data in the correction range C by referring to correction data. The correction unit 112 performs the aforementioned processing for each of the notches. The correction unit 112 performs similar processing for each of the peaks. With this procedure, the correction unit 112 can calculate a correction spectrum. It is therefore possible to prevent new extreme values from occurring in the correction spectrum in the correction range C. That is, the correction unit 112 interpolates data around the peaks and notches that have been shifted so that the number of extreme values of the spatial acoustic transfer characteristics does not increase due to the correction. It is therefore possible to prevent new local maximum values from being formed around each of the notches. Accordingly, it is possible to maintain the original waveform and perform correction appropriately.

The filter generation unit 114 generates a spatial acoustic filter using frequency-amplitude characteristics (correction spectrum) after the correction. For example, the filter generation unit 114 generates spatial acoustic transfer characteristics in a time domain by inverse Fourier transform or the like. Note that frequency-phase characteristics at the reference position can be used for frequency-phase characteristics in inverse transform. The filter generation unit 114 generates a spatial acoustic filter by cutting out the spatial acoustic transfer characteristics in the time domain with a predetermined filter length.

As described above, the correction unit 112 shifts the notch N2 based on the frequency difference value Df and the amplitude difference value Damp. That is, the correction unit 112 changes the frequency and the amplitude level of the notch N2. The correction unit 112 shifts the peaks P2 and P3 and the notches N1 and N3 based on the amplitude difference value Damp. That is, the correction unit 112 changes the amplitude level of each of the peaks P2 and P3 and the notches N1 and N3. The correction data storage unit 113 stores the amplitude difference value and the frequency difference value as correction data. Note that the correction unit 112 does not correct the peak P1.

Now, an example of the order in which the correction unit 112 corrects the peaks P2 and P3 and the notches N1-N3 will be described. In this example, the correction unit 112 may perform correction in the order of the notch N1, the peak P2, the notch N2, the peak P3, and the notch N3. Alternatively, the correction unit 112 may correct the notch N2 the last time where the frequency is shifted. Otherwise the correction unit 112 may correct the notch N3, the peak P3, the notch N2, the peak P2, and the notch N1 from the high-frequency side in sequence.

While the correction unit 112 corrects the frequency and the amplitude of each of notches based on the frequency difference value and the amplitude difference value in FIG. 19, the correction unit 112 may instead correct only the amplitude. That is, the correction unit 112 may vertically shift the amplitude by the frequency difference value. Further, the correction unit 112 may not correct all the notches N1-N3 and peaks P1-P4. For example, the correction unit 112 may not correct the peak P1. The correction unit 112 may further correct only one of the frequency or the amplitude. The correction unit 112 may correct both the frequency and the amplitude for some of the notches N1-N3 and correct only the amplitude for the rest of the notches. The correction unit 112 may correct only the amplitude of the peak without correcting the frequency of the peak.

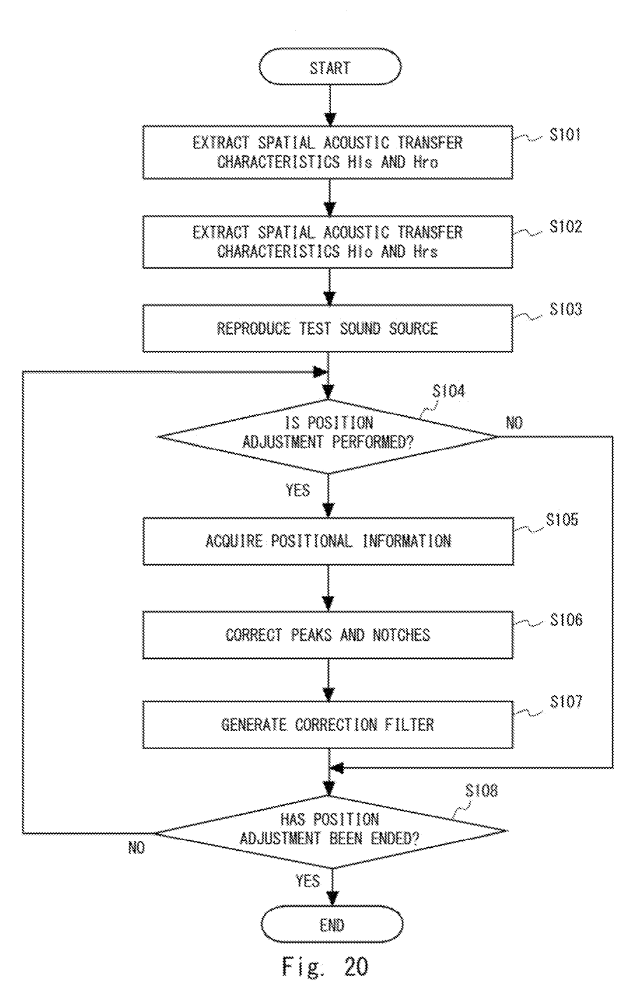

Next, with reference to FIG. 20, a filter generation method will be described. FIG. 20 is a flowchart showing the filter generation method.

First, the transfer characteristic acquisition unit 102 acquires spatial acoustic transfer characteristics Hls and Hro from preset data in the database 103 (S101). The transfer characteristic acquisition unit 102 extracts spatial acoustic transfer characteristics Hls and Hro of a person 1 being measured having ear canal transfer characteristics similar to ear canal transfer characteristics of the user for the user's left ear.

Likewise, the transfer characteristic acquisition unit 102 acquires spatial acoustic transfer characteristics Hlo and Hrs from the preset data in the database 103 (S102). The transfer characteristic acquisition unit 102 extracts spatial acoustic transfer characteristics Hlo and Hrs of a person 1 being measured having ear canal transfer characteristics similar to ear canal transfer characteristics of the user for the user's right ear.

Next, the out-of-head localization device 100 reproduces test signals of the test sound source 125 (S103). In this example, the out-of-head localization device 100 outputs reproduced signals on which out-of-head localization processing has been performed from the headphones 43. That is, the convolution processing unit 121 convolves a spatial acoustic filter indicating the extracted spatial acoustic transfer characteristics Hls, Hro, Hlo, and Hrs into the reproduced signals. Further, the inverse filter unit 123 convolves the inverse filter into the test signals of the reproduced signals. This enables the user to listen to the reproduced signals on which the out-of-head localization processing has been performed.

Next, the positional information acquisition unit 111 determines whether or not position adjustment is performed (S104). When, for example, the user U has moved the position adjustment bar (see FIG. 5), the positional information acquisition unit 111 determines that the position adjustment is performed (YES in S104). When the user U has not moved the position adjustment bar, the positional information acquisition unit 111 determines that the position adjustment is not performed (NO in S104). When the position adjustment is not performed (NO in S104), the process moves to Step S108.

When the position adjustment is performed (YES in S104), the positional information acquisition unit 111 acquires the positional information (S105). That is, the positional information acquisition unit 111 acquires the angle after the virtual sound source is changed.

The correction unit 112 corrects peaks and notches based on the positional information (S106). The correction unit 112 corrects the peaks and the notches by referring to the correction data. As described above, the correction unit 112 shifts the peaks and the notches by referring to the correction data. The correction unit 112 performs correction from one of the peaks and the notches located on the low-frequency side as appropriate. Accordingly, a correction spectrum obtained by correcting the amplitude spectrum can be obtained. Further, the correction unit 112 may correct peaks and notches included in some bands. The correction unit 112 may also correct peaks and notches in sequence from the low-frequency side. Alternatively, the correction unit 112 may correct peaks and notches in sequence from the high-frequency side. As a matter of course, the order in which the peaks and the notches are corrected is not particularly limited. The peaks and notches may be corrected in a predetermined order.

The filter generation unit 114 generates a correction filter using a correction spectrum (S107). That is, the filter generation unit 114 generates a correction filter indicating the spatial acoustic transfer characteristics by performing inverse Fourier transform on the correction spectrum. The correction filter shows spatial acoustic transfer characteristics from the sound source whose position has been changed in the vertical direction to the ears.

The positional information acquisition unit 111 determines whether or not the position adjustment has been ended (S108). For example, when the user U clears the checkbox of position adjustment ON in FIG. 5, the position adjustment is ended (YES in S108). Accordingly, the process is ended.

When the position adjustment has not ended (NO in S108), the process returns to Step S104. Therefore, the user U continuously listens to test signals on which out-of-head localization processing has been performed. The user U can perform position adjustment according to the result of performing out-of-head localization listening of the test signals. Accordingly, a spatial acoustic filter indicating spatial acoustic transfer characteristics at a virtual sound source position that the user U prefers is generated. Accordingly, the out-of-head localization device 100 can generate an appropriate filter, whereby effective out-of-head localization processing can be performed.

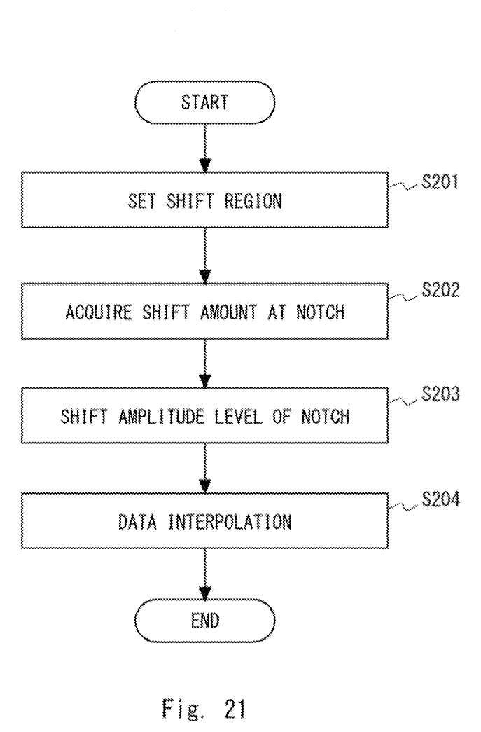

Next, with reference to FIG. 21, correction of notches or peaks will be described. FIG. 21 is a flowchart for describing processing for correcting a notch. FIG. 21 shows processing for correcting a notch and a peak other than the notch N2 where the frequency is shifted. Specifically, FIG. 21 shows processing for correcting the notch N1. That is, FIG. 21 shows correction for shifting only the amplitude level. Since the amplitude level of each of the notch N3 and the peaks P1-P3 can be shifted by performing processing similar to that shown in FIG. 21, detailed descriptions thereof will be omitted.

First, the setting unit 118 sets a shift region (S201). The shift region is a frequency range including the notch N1. When the Index value of the frequency of the notch N1 is denoted by fN1, the shift region can be equal to greater than (fN1-2) but equal to or smaller than (fN1+2). That is, fN1, and two indices on both sides of fN1 are each set as a shift region. For the notch N1 and the like, the number of indices to be in the shift region is set in advance. As a matter of course, the number of indices included in the shift region of the notch N1 is not limited to 5. The setting unit 118 may set the shift region of the notch N1 based on the frequency characteristics, like for the notch N2.

The correction unit 112 acquires the shift amount at the notch N1 based on the positional information (S202). The shift amount is indicated by the amplitude difference value Damp. The shift amount is a difference between (the amplitude level at the reference angle) and the (the amplitude level at the angle indicated by the positional information).

The correction unit 112 shifts the amplitude level of the notch N1 by the amplitude difference value Damp (S203). Accordingly, the amplitude level Amp(fN1) at fN1 is corrected. Next, data on both sides of the notch N1 is interpolated (S204). That is, the correction unit 112 obtains the amplitude levels on both sides of the notch N1 by data interpolation.

Accordingly, amplitude levels Amp(fN1-2), Amp(fN1-1), Amp(fN1+1), and Amp(fN1+1) of (fN1-2), (fN1-1), (fN1+1), and (fN1+2) are corrected. In this example, the correction unit 112 calculates amplitude levels Amp(fN1-2) and Amp(fN1-1) by performing linear interpolation using the amplitude level Amp(fN1-3), and Amp(fN1) after shifting. The correction unit 112 calculates the amplitude levels Amp(fN1+2) and Amp(fN1+1) by performing the linear interpolation using the amplitude level Amp(fN1+3), and Amp(fN1) after shifting.

According to the aforementioned procedure, the notch N1 can be appropriately corrected in accordance with the sound source position. The correction unit 112 performs correction for the notch N3 and the peaks P2 and P3 as well by performing processing similar to that in FIG. 21.

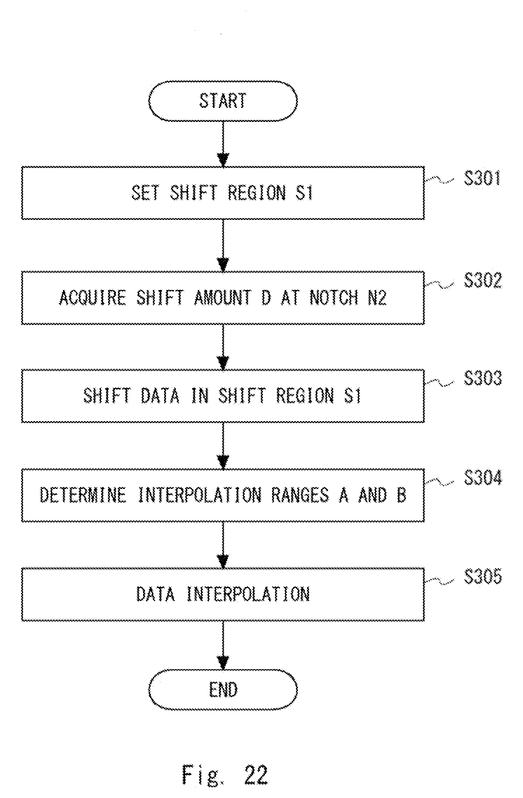

Next, with reference to FIG. 22, processing for correcting the notch N2 will be described. FIG. 22 is a flowchart for describing processing for correcting the notch N2. FIG. 22 shows correction for shifting an amplitude level and a frequency.

First, the setting unit 118 sets the shift region S1 (S301). As shown in FIG. 17, the setting unit 118 sets the shift region S1 based on extreme values in the vicinity of the notch N2. The Index value of the frequency of the notch N2 is denoted by fN2. fN2 is a value smaller than the upper-limit frequency fmax but is larger than the lower-limit frequency fmin.

The correction unit 112 acquires a shift amount D at the notch N2 based on the positional information (S302). The shift amount D is indicated by a frequency difference value Df and an amplitude difference value Damp. The amplitude difference value Damp is a difference between (the amplitude level at the reference angle) and (the amplitude level at the angle indicated by the positional information). The frequency difference value Df corresponds to a difference between (the frequency of the notch N2 at the reference angle) and (the frequency of the notch N2 at the angle indicated by the positional information).

The correction unit 112 shifts the data in the shift region S1 by the shift amount D (S303). Next, the correction unit 112 determines the interpolation ranges A and B (S304). The correction unit 112 determines the interpolation range by comparing the amplitude level of the shift data with an amplitude level at a frequency at which data is not shifted. The ranges in the vicinity of the both ends of the shift data S2 correspond to the interpolation ranges A and B. The interpolation range A is an interpolation range which is on a low-frequency side with respect to the notch N2. The interpolation range B is a range which is on a high-frequency side with respect to the notch N2.

The correction unit 112 performs the data interpolation in order to obtain amplitude levels of the interpolation ranges A and B (S305). The correction unit 112 can perform data interpolation by linear interpolation. Alternatively, the correction unit 112 obtains data interpolation by using a quadratic curve. The data interpolation is performed in the interpolation ranges A and B. It is therefore possible to prevent extreme values from being newly generated around the notch N2 (see FIG. 18). The correction of the notch N2 is thus ended. For the region other than the shift region, original amplitude values can be used. With this configuration, it is possible to appropriately correct the notch N2.

Note that at least a part of the processing in the out-of-head localization device 100 may be performed in another device. That is, the above-described processing may be performed by a plurality of apparatuses in a distributed manner. For example, the filter generation device 110 and the out-of-head localization device 100 may be physically separate devices. In this case, the spatial acoustic filter generated by the filter generation device 110 may be transmitted to the out-of-head localization device 100. Alternatively, the spatial acoustic transfer characteristics corrected by the correction unit 112 may be transmitted to the out-of-head localization device 100, and the out-of-head localization device 100 may generate an inverse filter.

The processing for selecting spatial acoustic transfer characteristics suitable for the user from the preset data may be performed by a server device other than the out-of-head localization device 100. Further, the database 103 and the correction data storage unit 113 may be mounted on a server device or the like connected to the network.

A part or the whole of the above-described processing may be executed by a computer program. The above-described program can be stored and provided to the computer using any type of non-transitory computer readable medium. The non-transitory computer readable medium includes any type of tangible storage medium. Examples of the non-transitory computer readable medium include magnetic storage media (such as flexible disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although embodiments of the invention made by the present inventors are specifically described in the foregoing, the present invention is not restricted to the above-described embodiments, and various changes and modifications may be made without departing from the scope of the invention.

The present invention relates to a filter generation technique based on spatial acoustic transfer characteristics.

What is claimed is:

1. A filter generation device comprising:
a transfer characteristic acquisition unit configured to acquire spatial acoustic transfer characteristics from a sound source to an ear of a person being measured;
a positional information acquisition unit configured to acquire positional information of the sound source in a vertical direction using a direction horizontal to a height of an ear of the person being measured as a reference position;
a correction unit configured to correct the spatial acoustic transfer characteristics based on the positional information; and
a filter generation unit configured to generate a correction filter based on the corrected spatial acoustic transfer characteristics.

2. The filter generation device according to claim 1, further comprising:
a specifying unit configured to specify notches of frequency characteristics of the spatial acoustic transfer characteristics,
wherein the correction unit corrects, based on the positional information, a frequency and a level of a second notch, which is on the second of the frequency characteristics from a low-frequency side.

3. The filter generation device according to claim 2, wherein the correction unit corrects a level of a first notch, which is on the first of the frequency characteristics from the low-frequency side.

4. The filter generation device according to claim 3, wherein
the specifying unit specifies peaks of the frequency characteristics, and
the correction unit corrects:
a level of a third notch, which is on the third of the frequency characteristics from the low-frequency side;
a level of a second peak, which is on the second of the frequency characteristics from the low-frequency side; and
a level of a third peak, which is on the third of the frequency characteristics from the low-frequency side.

5. An out-of-head localization device comprising: the filter generation device according to claim 2;
a convolution processing unit configured to convolve the correction filter into a reproduced signal;
an inverse filter unit configured to convolve an inverse filter for canceling characteristics of headphones or earphones into the reproduced signal into which the correction filter is convolved; and
an output unit configured to output the reproduced signal into which the inverse filter is convolved.

6. A filter generation method comprising:
a step of acquiring spatial acoustic transfer characteristics from a sound source to an ear of a person being measured;
a step of acquiring positional information of the sound source in a vertical direction using a direction horizontal to a height of the ear of the person being measured as a reference position;
a step of specifying a notch of frequency characteristics of the spatial acoustic transfer characteristics;
a step of correcting, based on the positional information, a frequency and a level of a second notch, which is on the second of the frequency characteristics from a low-frequency side; and
a step of generating a correction filter based on the corrected spatial acoustic transfer characteristics.

7. The filter generation device according to claim 1, further comprising:
a specifying unit configured to specify a peak or a notch of frequency characteristics of the spatial acoustic transfer characteristics; and
a setting unit configured to set a shift region including the peak or the notch of the frequency characteristics,
wherein the correction unit corrects the spatial acoustic transfer characteristics by shifting data in the shift region in accordance with the positional information while maintaining a shape of the peak or the notch in the shift region.

8. The filter generation device according to claim 7, comprising determining both ends of the shift region on a frequency axis according to the frequency characteristics.

9. The filter generation device according to claim 8, wherein the setting unit determines the both ends of the shift region in accordance with extreme values of the frequency characteristics on both sides of the peak or the notch.

10. An out-of-head localization device comprising: the filter generation device according to claim 7;
a convolution processing unit configured to convolve the correction filter into a reproduced signal;
an inverse filter unit configured to convolve an inverse filter for canceling characteristics of headphones or earphones into the reproduced signal into which the correction filter is convolved; and
an output unit configured to output the reproduced signal into which the inverse filter is convolved.

11. A filter generation method comprising:
a step of acquiring spatial acoustic transfer characteristics from a sound source to an ear of a person being measured;
a step of acquiring positional information of the sound source in a vertical direction using a direction horizontal to a height of the ear of the person being measured as a reference position;
a step of specifying a peak or a notch of frequency characteristics of the spatial acoustic transfer characteristics;
a step of setting a shift region including the peak or the notch of the frequency characteristics;
a step of correcting the spatial acoustic transfer characteristics by shifting data in the shift region in accordance with the positional information while maintaining a shape of the peak or the notch in the shift region; and
a step of generating a correction filter based on the corrected spatial acoustic transfer characteristics.

12. The filter generation device according to claim 1, further comprising:
a preset data storage unit configured to store preset data in accordance with the spatial acoustic transfer characteristics, the preset data storage unit storing preset data in accordance with spatial acoustic transfer characteristics obtained by measurement on a plurality of persons being measured; and
a correction data storage unit configured to store correction data for correcting the spatial acoustic transfer characteristics in accordance with the position of the sound source in the vertical direction using a direction horizontal to a height of an ear of the person being measured as a reference position, the correction data storage unit storing, for each of the persons being measured, correction data obtained from frequency characteristics of spatial acoustic transfer characteristics measured by changing the position of the sound source in the vertical direction relative to the person being measured, wherein
the transfer characteristic acquisition unit extracts spatial acoustic transfer characteristics from the preset data storage unit, and
the correction unit is configured to correct the spatial acoustic transfer characteristics by using the correction data, the correction unit correcting a peak and a notch of the frequency characteristics of the spatial acoustic transfer characteristics in accordance with the positional information.

13. The filter generation device according to claim 12, wherein the correction data includes data regarding a frequency and amplitude of the notch of frequency characteristics of the preset data, and the correction unit corrects the notch of the spatial acoustic transfer characteristics according to the correction data.

14. The filter generation device according to claim 13, wherein the correction data storage unit stores, as correction data, a calculation formula obtained from a table showing a notch or a peak, the correction unit calculates a shift amount by inputting the positional information in the vertical direction into the calculation formula, and the correction unit performs correction by shifting the peak and notch by the shift amount.

15. An out-of-head localization device comprising: the filter generation device according to claim 12;
a convolution processing unit configured to convolve the correction filter into a reproduced signal;
an inverse filter unit configured to convolve an inverse filter for canceling characteristics of headphones or earphones into the reproduced signal into which the correction filter is convolved; and
an output unit configured to output the reproduced signal into which the inverse filter is convolved.
